(19) United States
(12) Patent Application Publication
(10) Pub. No.: US 2008/0126406 A1
(43) Pub. Date: May 29, 2008

(54) Complexity management tool

(76) Inventors: Aruna Sri Endabetla, Murrysville, PA (US); Thomas J. Clancy, Canonsburg, PA (US)

Correspondence Address: ANDREW J. CORNELIUS, KEEVICAN WEISS BAUERLE;& HIRSCH LLC, 11 TH FLOOR, FEDERATED INVESTORS TOWER, 1001 LIBERTY AVENUE, PITTSBURGH, PA, 15222, US

(21) Appl. No.: 11/900,626

(22) Filed: Sep. 12, 2007

Related U.S. Application Data
(60) Provisional application No. 60/825,392, filed on Sep. 12, 2006.

(51) Int. Cl. G06F 7/00

(52) U.S. Cl. 707/103 R; 707/E17.055

(57) ABSTRACT

An object-based modeling system, method and computer apparatus models a real life process. They include model objects that represent resources used by the modeled process, and an agent link associated with each model object. Each agent link determines the status of one or more resources, and exercises control over them. A solution domain is defined in which one or more model objects is stored. A set of rules is associated with the model objects, and is applied to the objects.

### CROSS REFERENCE TO RELATED APPLICATIONS

This application claims the benefit of U.S. Provisional patent application Ser. No. 60/825,392, filed Sep. 12, 2006, entitled “Complexity Management Tool,” by the same inventors, the entire content of which is incorporated herein by reference.

### TECHNICAL FIELD

The present invention relates to complexity management, more particularly, the present invention relates to effective tools for complexity management.

### BACKGROUND ART

Sometimes it seems as though the application of technology to business processes is being driven more by buzzwords than by real requirements. There are literally hundreds of companies who are promising to “re-engineer business processes”, “mine business intelligence”, or “manage knowledge”. It's hard not to get excited about some or all of these things, because they all purport to offer companies a handle on optimizing how technology can improve their business.

The problem is that business isn't about “re-engineering”, or “mining” or even “knowing”, it's about doing. A bank executive summed it up best; “I don't want decision support, I want to be told what to do”. There is no question that having the information needed to make a decision is a good thing, but having real and direct help in making that decision is better. There's no question that engineering knowledge can be helpful, but engineering solutions to business problems is critical.

Running a business is a top-down process. Solving problems or addressing opportunities is an on-the-spot, reactive, process. How does this contradiction get reconciled? On the one hand, no company ever had a successful management-by-objectives program by taking low-level objectives and summarizing upward to figure out how a company should operate to meet its line management goals. Line management goals have to be organized to meet company goals. On the other hand, you can't redefine how your company does business every time you start a project to install new software or change your channel of distribution.

Businesses address issues when they become important, and this tends to create a wide set of specialized solutions to local problems, solutions that don't add up to an objective view of how the company should be run or even integrate well with each other. The fragmented approach to problems isn't likely to change, because no company could ever survive a complete top-down reconstruction of practices; the disruption in sales and production would surely destroy any who tried.

Technology seems to only make this worse; technical products aimed at specific technology issues like backup and recovery, security, compliance, and virtualization of resources end up colliding with technical solutions to specific low-level business needs, creating another set of integration problems.

Taken in this light, “data mining” or “business intelligence” isn't much more than spending money to find out things that you needed to know at the business level and didn't obtain at the project level. “Business Process Re-Engineering” is changing how you do business to accommodate all the little project things you did, some of which were never intended to bring about high-level changes at all. “Business policy management” is making rules that make sense of chaos that should never have developed. Ironically, the fact that these functions are separated not only from the projects that change how business works but also the people who manage the business overall means that they've created their own integration and process engineering problem. Often the attempted solution to complexity and lack of integration is to add non-integrated things, creating more complexity.

### DISCLOSURE OF INVENTION

Enough's enough. What's needed here is a completely new approach to applying technology to business processes and organizing solutions to local problems into structured elements in solutions to problems at the total business level. We call that “solution engineering”, and the present application outlines tools to support it.

Thus, a method, computer apparatus and system for object-based modeling is provided.

It is noted that, as used in this specification, the singular forms “a,” “an,” and “the” include plural referents unless expressly and unequivocally limited to one referent. For the purposes of this specification, unless otherwise indicated, all numbers expressing any parameters used in the specification and claims are to be understood as being modified in all instances by the term “about.” All numerical ranges herein include all numerical values and ranges of all numerical values within the recited numerical ranges.

The various embodiments and examples of the present invention as presented herein are understood to be illustrative of the present invention and not restrictive thereof and are non-limiting with respect to the scope of the invention.

### BRIEF DESCRIPTION OF DRAWINGS

FIG. 1 is a graphical representation of the hierarchy of a business;

FIG. 2 is a graphical representation of the inputs and outputs of an OBJECTive Engine;

FIG. 3 is a graphical representation of the structure of an OBJECTIVive solution domain;

FIG. 4 is a graphical representation of solutions, objects and agents;

FIG. 5 is a graphical representation of a “portlet” solution domain;

FIG. 6 is a block diagram showing the use of external protocols and messages to create events;

FIG. 7 is a graphical representation of VISPA architecture;

FIG. 8 is a graphical representation of the service subscription solution domain structure;

FIG. 9 is a block diagram of the general VISPA directory-based application mapping model;

FIG. 10 is a block diagram of resource and policy mapping;

FIG. 11 is a block diagram showing resource mapping in VISPA;

FIG. 12 is a graphical representation showing the framework of the server virtualization example;

FIG. 13 is a graphical representation of resource discovery and management;

FIG. 14 is a block diagram showing resource mapping in VISPA;

FIG. 15 is a graphical representation illustrating the extension of VISPA;

FIG. 16 is a block diagram showing SOAComply architecture;

FIG. 17 is a graphical representation of the TrueBaseline Object Model;

FIG. 18 is a block diagram showing the tree structure of SOAComply relationships;

FIG. 19 is a block diagram showing an example of an optimum-query;

FIG. 20 is a block diagram showing two examples of distributed object model development;

FIG. 21 is a block diagram of the events and the object model;

FIG. 22 is a block diagram showing advanced object modeling for a virtual service projection architecture;

FIG. 23 is a graphical representation of the dynamic and distributed nature of SOA business process;

FIG. 24 is a graphical representation of the relationship among application object modeling, system object modeling, operationalization rules, and application footprints; and

FIG. 25 is a graphical representation of the creation All-Dimensional Compliance.

### BEST MODE FOR CARRYING OUT THE INVENTION

The applicant's, also references as the assignee TrueBaseline's, TrueSMS, SOAComply, and ViSPA are based on our unique object-oriented architecture, which combines the best aspects of object technology with the principles of virtual machine technology, the basis for modern concepts like Java. Java programs run on a Java Virtual Machine, and the TrueBaseline object framework, TrueOMF, creates an object virtual machine that runs “object programs”. The process of creating applications for TrueOMF is called Solution Engineering.

TrueOMF recognizes two basic types of objects, model objects and agent objects. The normal way to create an application for TrueOMF is to begin by using the model objects to model the business, technology, and information structures of the real-world operation that the application will support. This can be done using what appear to be standard prototyping principles; a high-level structure would be created first, and then elements of that structure decomposed to lower-level functions, and so forth until the desired level of detail is reached. This prototyping is done using modeling objects, each of which can be given names, and each of which can represent people, decisions, policies, information elements, customers, technology resources, etc.

When a model is defined, the basic rules that govern information flow through the model, including the high-level decisions, are defined, using abstract data names to represent information that will come from the real world. This process can then be tested with our unique object-based tools to validate that it represents the way that the high-level process being modeled would really work.

When the model is defined and validated, each of the model objects that represent a real-world resource, process, policy, etc., is replaced by an agent object that links to that real-world element. The information that is expected to be obtained from the outside world is then mapped into those abstract data names used by the model, and the outputs to the real world are mapped from those abstract names into the form required by the real outside resource, process, policy, or even person. When this process is completed, the model represents a running object representation of a real process, and because each object links to its real-world counterpart, it will be driven by real-world inputs and drive real processes and resources with its outputs. The model is now the process, controlling it totally based on the policy rules that have been defined.

In order to create an object application based on TrueOMF, there must be both a source of knowledge on the outside process being modeled and a source of knowledge on the TrueOMF modeling and application-building tool set. Ideally, a single person with knowledge in both areas would be used to create a model, and that person would be called a solution engineer. TrueBaseline's SOAP program will certify Subject Matter Experts in TrueOMF principles and designate them Certified Solution Engineers (“CSEs”) for a given area. A list of CSEs will be provided by TrueBaseline in conjunction with TrueOMF application development projects, and Subject Matter Experts, integrators, developers, etc., are invited to join the program and obtain certification and listing by TrueBaseline.

TrueBaseline has developed a series of Application Frameworks which are solution-engineered application models designed to support specific important industry tasks. The Application Frameworks currently designated are:
TrueSMS, an Application Framework to create user/employee services by combining network and application/system resources, and then deploy these services on infrastructure through a set of automated tools. TrueSMS provides service management system capabilities for service providers and enterprises that operate internal (private) networks.
SOAComply, an Application Framework to test servers and client systems for compliance with hardware configuration, software version, software configuration, and technology policy compliance, and to identify systems that are designated to run specific applications and locate those that are not designated but nevertheless using those applications. This Application Framework is scalable to multi-clientand-server installations typical of those to be deployed for SOA.
ViSPA, an Application Framework for virtualization and virtual service and resource projection. ViSPA creates an object policy layer between resources and users and permits cross-mapping only when the use conforms to local policy. ViSPA also controls resource replication and load sharing, fail-over processes and policies, and resource use auditing.

CSEs can use these Application Frameworks to create specific applications targeted at company-specific needs, horizontal markets, vertical markets, etc. TrueBaseline wants to talk with VARs and systems/network integrators with skills in any of the above areas, or in other areas where TrueOMF principles could be applied, to discuss activities of mutual interest and benefit through membership in our SOAP2 software partnership program.

Companies solve problems within the scope of those problems. The goal of most business or technology projects is to address a problem or opportunity in a contained way, limiting its impact on the rest of the business. We call the scope of a business problem or opportunity its solution domain. Basically, a solution domain is the scope of business and technology processes that address a specific business goal, problem, or process. It's the logical equivalent of a task group, a work group, a department, an assignment.

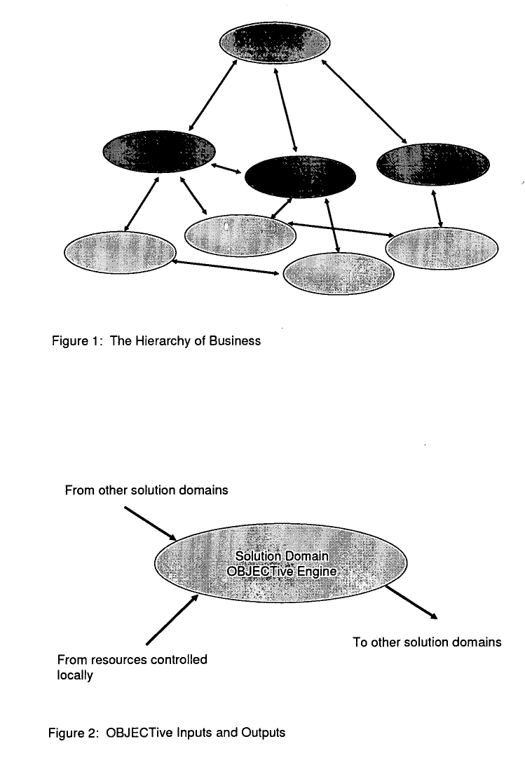

In a way, a solution domain is a kind of black box. It provides a business function in some unique internal way, but it also has to fit into the overall business process flow, providing input to other solution domains and perhaps getting inputs of its own from those other domains. On top of all of this is a set of management processes that get information from all of the lower processes. FIG. 1 shows this kind of structure.

If businesses work this way, why not solve business problems this way? We asked that very question, and we developed a model that did. The present invention uses the industry-proven concept of object management to create a model or structure that defines a solution domain. We call this process operationalization, which means the use of a model to apply business-based solutions automatically.

The model used for operationalization has all of the properties of a real business process, and so it both represents and controls real business processes, and the technology tools that support them. Problems can be solved, opportunities addressed, in any order that makes business sense, and each new solution domain interconnects with all the others to exchange information and build value. The more you do with our solution domains, the more completely you address business problems in a single, flexible, and extensible way. In the end, you create a hierarchy of solution domains that match FIG. 1, a natural, self-integrating, self-organizing system.

The core of our approach is something we call the OBJECTive Engine. This engine is a solution to the exploding complexity problems created by the intersection of service-oriented architecture (SOA) deployment and increased business compliance demands. The goal of OBJECTive is the operationalization of a problem/solution process, the fulfillment of a specific business or technical need. This goal isn't unique; it's the same goal as many software tools and business requirements languages profess.

What is unique is the way that OBJECTive achieves that goal—which is the same way a business or a worker would achieve it. An OBJECTive Engine represents each solution domain and controls the resources that are primarily owned by that domain. As FIG. 2 shows, OBJECTive draws information from other solution domains and offers its own information to other domains to create cooperative behavior. OBJECTive also draws information from the resources it controls, through agents described later in this application.

Just as an organization or task group within a company has specific internal processes, rules, and resources, so does an OBJECTive solution domain. Just as an organization has fixed interactions with the rest of the company, set by policy, so does an OBJECTive solution domain. Just as the information detailing the operation, history, state, and processes of an organization are available for review by management, so are those attributes in an OBJECTive solution domain.

OBJECTive is an object-based business and technology problem/solution modeling system that offers an elegant, flexible, and powerful approach to automating the organization, interaction, and operation of business processes. The key features are:
Objects represent human, technology, and partner resources, and each object has an “agent” link that obtains status from those resources and exercises control over them. These objects can be created and stored once, in the solution domain where their primary ownership and control resides, but they are available throughout the company.
Objects represent business processes or process steps, both at the detailed level and at the total process level. An entire solution domain can be an “object” in another.
Business rules can be applied to any kind of object, whether the object represents a resource, a process, a partner, a program . . . and rules are inherited with the objects they apply to, so the “owner” can enforce conditions that others will inherit.
The current software tools that run a business can themselves be objects, and in fact entire software systems can be objects. This means that OBJECTive can organize the tools already in use, eliminating any risk that expensive software or hardware will be stranded by changes.
OBJECTive is distributed, scalable, redundant. Because solution domains can contain other solution domains, performance and availability can be addressed by simply adding more OBJECTive engines, and any such engine can support one or more domains, either in parallel for performance or either/or for failover.
OBJECTive's logic is written in OBJECTive. Programmers will tell you that the first test of a new “computer language” is whether the programming tools for the language can be written in the language itself. This makes OBJECTive self-managing and easily modified.
There is no limit to the application of OBJECTive. You can update software, virtualize servers, test for compliance, load boxcars or trucks, dispatch service technicians, optimize customer contact, route your network traffic . . . every business/technology function can be modeled in an OBJECTive solution domain, and every such domain offers complete business integration and control with every other domain.
A solution domain can be created for a class of workers or even an individual worker to create functional orchestration. Today, many popular products offer integrated graphical user interfaces, screen orchestration features that let worker displays be customized to their tasks. OBJECTive customizes not the interface but the processes, resources, and applications themselves. Every job can be supported by a slice across every process, function, resource, partner, customer, or tool in the company's arsenal.
Business processes are dynamic and ever-changing. OBJECTive can be self-authoring and self-modifying. “Wizards” written in OBJECTive will help set up solution domains and make changes to them as needed. With objects representing artificial intelligence tools, OBJECTive can even be self-learning.

Some people will say that other products do what OBJECTive does. There are point solutions for many business problems, and many business problems to solve. Does that then mean that organizations will substitute the frustration of organizing their solutions for the frustration of organizing their problems? We think that's a bad idea.

Some will say that OBJECTive is a kind of “software god-box”, a single strategy that purports to solve all problems, but OBJECTive solves problems by enveloping the solutions already in place and creating new solutions where none existed. Every business solves all problems . . . simply to survive. Should its tools admit to a lower level of functionality, a narrower goal, simply because it's easier or more credible?

There is no reason why technology has to make things more complicated. OBJECTive proves that.

How OBJECTive Works

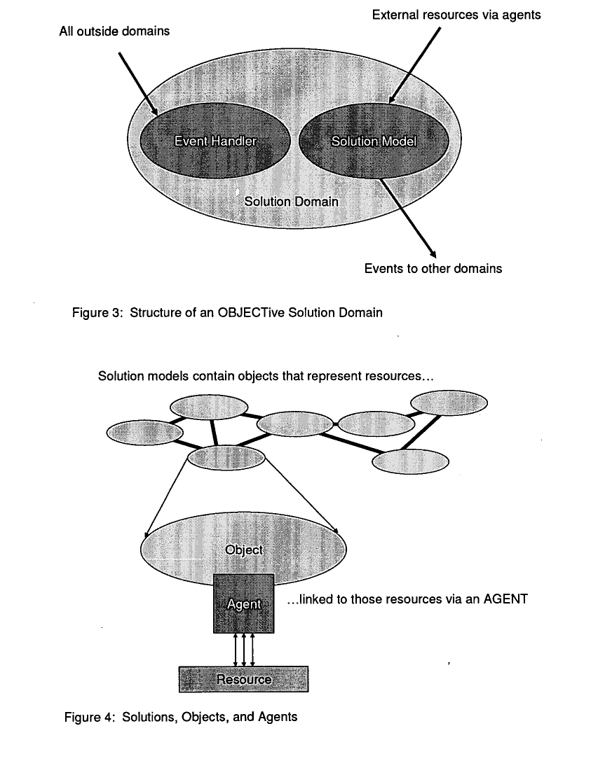

FIG. 3 shows a graphic view of an OBJECTive solution domain. As the figure shows, each solution domain contains two key elements:
A solution model that describes how resources, commitments, applications, partners, processes, and goals are related for the problem set that's being worked on. To solve a problem or perform a task, OBJECTive analyzes this model in various ways. The solution model is made up of objects, and some of these objects will draw data from controlled resources via agents, or generate events to other domains.
An event handler that processes requests from other solution domains. These requests are similar to the phone calls, emails, memos, or process manuals or other business communications elements that link business processes today. If you want a solution domain to find out something, or to do something, an event is used to make the request.

The solution model is made up of a linked collection of objects, each of which represents a resource, function, application, commitment, etc. The specific structure of the solution model depends on the problem, but in general the model is made up of three separate structures:

1. A resource model that defines the resources that are available to solve the problem and the ways in which the resources are interdependent. This model might simply be a list of computers (which are not interdependent in that each can be assigned a task separately), a map of a network (whose nodes are linked with specific circuits), etc.

2. A commitment model that defines how tools or processes consume resources. An example would be the requirements that an application poses on configuration and software setup on client and server systems, or the way that a connection between two network endpoints consumes node and trunk capacity.

3. A business process model that links the commitment model to the problem by showing how each step toward solution commits resources.

Some of the objects used in the solution model are “navigational” in nature meaning that they link the model together to create the relationships necessary for each of the three general structures above. Other objects represent “real” things, business tools, resources, or elements. These representational objects are linked to the thing(s) they represent through a software element called an agent. As FIG. 4 shows, the agent makes the object a true representative of its “target”. Agents gather status from the target so that the conditions there can be tested by rules in the solution model. Agents also exercise control over the target so that decisions can be implemented directly.

There are two general classes of agents:

1. Resource agents that represent real physical resources, generally technology resources from which automated status telemetry is available through some management interface.

2. Functional agents that represent functions or processes that do something specific. Functional agents can be components of solution logic, or they can be external software systems or programs, and even manual processes. Any such external process can be turned into an object by adding a special wrapper that allows it to communicate with a functional agent.

Agents are written to a well-defined interface that can be a combination of web service, API, or other well-known inter-software exchange mechanism. The applicants have published the specifications for both types of agent interfaces. Certain interfaces for functional agents used for open source software “wrapping” will be made available as open source software.

Open source software support is an important element of OBJECTive's functional agent strategy. The applicants, or assignee TrueBaseline, will provide an open source forum as part of its SOAP2 program, which does not require special membership procedures or NDAs. Under this program, TrueBaseline opens its wrapper base code for inclusion in open source custom wrappers for any open source application.

The event handler of OBJECTive is itself a solution model (remember, OBJECTive is written in itself, as a collection of objects). This model allows each solution domain to recognize “events” generated by other solution domains or other software systems. The event handler is a web service that posts an event with specific structure to the event handler for processing. In the event handler, the solution model decodes the event and matches each type of event to a particular execution of the solution model. Results of an event can be returned synchronously (as a response to the message) or asynchronously (as another event which is in turn generated by executing a web service). The specifications for both types of event usage are available to SOAP2 partners.

Every function of a solution domain can be exposed through the event handler, and so every function is equally available to other solution domains and to any application that properly executes the event web service. This means that an OBJECTive solution domain can appear as a web service or set of web services to any application, and that all OBJECTive solutions are available to all of the web service syndication/orchestration platforms being developed, including Microsoft's Dynamics and SAP's NetWeaver.

Because OBJECTive can encapsulate any application or system of applications as an object and because any object can be activated by an event, OBJECTive can expose every software application or application system as a web service (FIG. 5), becoming what is in effect a “portlet”.

Since access rules can be provided to manage who and how this object is accessed, business rules on application use can be applied by a solution domain and will be enforced uniformly. OBJECTive can thus apply security and business rules to SOA/web services access. Note that this can be done separately as a “security solution domain” or as a part of any other solution domain's behavior. Similarly, the processes within a solution domain exposed through the event interface can be managed via business policies, so each “owned” process is regulated by its owner.

Because events are the key to connecting a solution domain to the outside world, they can be created by things besides other solution domains and the use of the web service interface by external applications. In fact, anything that creates a “signal” can be made to create an event through the use of an event proxy.

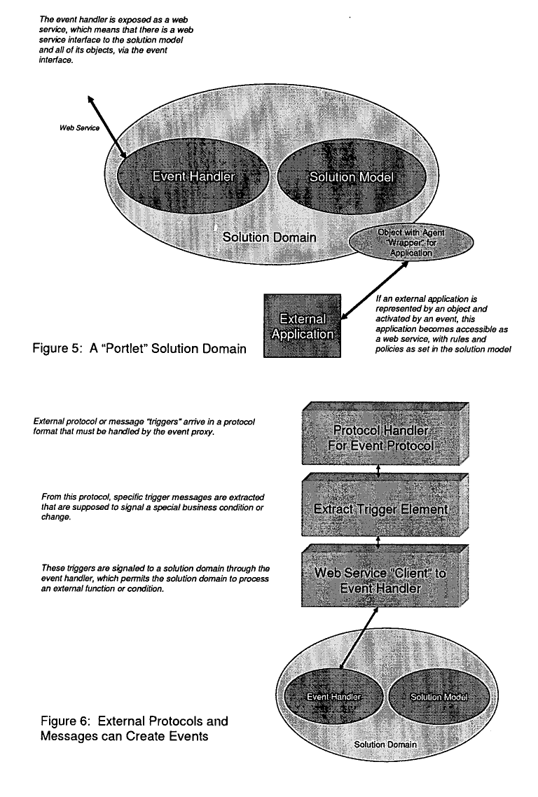

This is a software element that on the “inside” acts as a web service client to generate a transaction to the event interface of a solution domain, and on the “outside” acts as a kind of receptor for an external signal or condition. FIG. 6 shows graphically how an event proxy works.

Event proxies can be used to generate an event based on any of the following:
Any recognized protocol element, such as an IP “Ping”, an SNMP request, or even simply a datagram sent to a specific IP address or port.
A message, in the form of an email, IM, SMS message, or even VoIP call.
The scanning of a barcode, RFID, etc.
A sensor indictor or warning in any industrial control protocol. The ability to convert external conditions into events is incredibly powerful. With this capability, a solution domain can create a “handler” for virtually any set of outside conditions, ranging from protocols to environmental conditions. In fact, a solution domain can respond to emails, make VoIP calls (or route them according to policy), and guide business processes.

Solution Domains and Solution Models

The object structure that is needed in a solution domain is pretty obviously linked to the way that the problem set can be solved. For a network routing problem, for example, the solution domain must model a network and pick a route. For SOAComply, it must model hierarchical relationships (trees). Each object set in a solution domain models a component of the problem and the path to solving it, and there may be multiple interrelated object sets. In SOAComply, for example, there is a set of application objects and a set of resource objects, combined in a query object set to test compliance.

The overall process of solution domain modeling is what we have called operationalization. This starts with the definition of a set of constraint models which are normally models of resources, extends to the definition of a set of consumption models which represent resource commitments like the running of applications or the routing of connections, and ends with the definition of business rules that link the resources to the consumption. This virtualization overall will represent “atoms” of resources/constraints, commitments/applications, and rules/processes as objects.

The objects in an object set can be one or more of the following types:
Resource objects, which represent either atomic resources or sets of resources that are “known” to the model as single object. Note that these “sets” are not the same as “collections”; in the latter, the atomic objects are visible and in the former they are modeled as part of a resource system whose details are generally opaque. A true resource object will always have a resource agent that links to a control/telemetry framework that allows access to the resource.
Commitment objects, which represent how resources are committed. Commitment objects are normally equipped with a set of rules, often defined in several ways to represent different operating states of the commitment of resources. Application objects in SOAComply are commitment objects.
Navigation objects, which provide a mechanism to link objects together. Link objects, route objects, and process objects are all navigation objects.
Functional objects, which represent a piece of business logic. These objects are used to perform a software function rather than check status of resources. They contain the link to the software function in the form of a functional agent that replaces the standard agent.

The process of analyzing a solution domain's object model is called querying. The query simply requests an analysis of the resources, rules, commitments, etc. that make up the problem, and from that analysis offers a solution according to the rules and status of the solution domain's environment. The process of querying includes an identification of the problem to be solved and any parameters that constrain the solution and are not extracted from resource state. Operating states are examples of these parameters.

In order to run a query, the object model of the solution domain must be analyzed and converted into a set of object sequences called parse paths. Each parse path is a linear list of object (created by a Route Object) that are analyzed in order, first by parsing down from the head and then (optionally) up from the tail. The process of creating the parse paths to query is the process described as parsing the object model, which simply converts the model into a series of these parse paths. This process depends on the structure of the model, which depends in turn on how the solution domain is structured, or its solution model.

There appear to be three distinct “solution models” or types of object relationships that would be required to cover all of the problems, and this paper introduces and explains each.

The three relationships are:

1. Hierarchy relationships, which are resource compliance relationships. These are almost “organizational” in that they model the compliance with a business process by creating a tree that is checked in its entirety for conformance to rules that are contained in its objects. It produces a go/no-go result, and the rule tests are not conditional, meaning that there is no rule that says “if CONDITION then DO X else DO Y” in the definition of the solution. This is the SOAComply model.

2. Networked relationships, which are either representations of problems that are based on a physical mesh of resources (a network, a highway system, etc.) or that are business alternatives that must be evaluated relative to each other for optimality. These require both a conversion into a convenient structure for evaluation (what is called “parsing”) and a score-based “optimal” query structure instead of a simple yes/no.

3. Script relationships, which are essentially programs written in “object language”. These are linear executions of objects whose order is determined by tests conducted in the rules; they have an “IF/THEN” test and selective redirection potential. In effect, they are logic descriptions.

These would be used to build wizards, to author internal processes, etc.

There are specific ways in which the solution model is parsed for each of these basic models.

Hierarchical Solution Models

A hierarchical solution model like that of SOAComply supports a solution domain where the “problem” is the compliance of a resource set (resource objects and collections) to a condition standard that is set by the combination of how resources are consumed (application objects) and business problems (queries setting application and operating state requirements). In such a solution model, the process of modeling a problem

is the process of building a tree that combines applications and resources and defines operating states. This tree is then parsed to create a set of parse paths that traverse from the top object to the end of each branch.

No “closed” paths are permitted, and no conditional paths (where the branch to traverse depends on the result of the testing of rules) are permitted. The set of parse paths created is equal in size to the set of “tips” on the branches. [Note: It may be that in creating parse paths to query, we would want to start at the branch tips and build the parse path backward because this would insure coverage with minimal logic to find each path]

Hierarchical models are suitable for solution domains that define compliance rules that are all dependent only on a higher standard (the set of application standards defined by the application objects) and not on interdependencies between the state of different resources.

Network Solution Models

A network solution model is modeled as a set of interdependent resources, meaning resources whose fixed relationships must be considered when solving the problem. A network routing problem is a good example of this; the best route between two points in a network must consider not only the current network state (its load of traffic) but also where the physical links really are located, since traffic can pass only on real connections between resources.

The processing of a network model into parse paths is the same process used in routing to determine the best route. In effect, each path that will serve to connect source to destination is listed as a parse path, and the paths are evaluated to find the one with the highest optimality score. There are a variety of algorithms (Dijkstra's is the most popular) to perform this type of dissection of a network mesh into parse paths; implementation is trivial.

Network models are suitable for solution domains that assess any problem that can be called a “routing problem”, including network problems, work flow, traffic management, etc. In general, they model problems that have a mandated sequence of steps, the optimum set of which must be selected.

Script Solution Models

A script solution model is the most general of all model types, applicable to any solution domain. In a script solution model, the problem assessment and solution are structured as a series of defined steps (Do A, Do B, etc.) which can be broken as needed by conditional statements (IF x DO y Else DO z). Parsing these models means moving from the starting point forward to the first conditional and parsing that as a path, then selecting the next path to parse based on the results of the first pass, etc.

Unlike the other solution models, script models do not require that all objects in the model be parsed to find a solution. In the network or hierarchical model, for example, the entire query model is parsed. In the former case, the total result is a go/no-go. In the latter case, each parse path is “scored” with the selected path the most optimum. In either case, the parse process is completed before any test results are used. In a script model, each parse path can set conditions which determine what the next parse path will be, making the script model very “programming-like”.

Because the script model is the most general of all models, solution domains that are handled in other models can also be handled via the script model. For example, a compliance test could be “scripted” by simply defining a set of object tests representing the compliance requirements for each system in order. A network routing problem could be handled by scripting a test of each “hop” (note that neither of these approaches would necessarily be easy or optimum; this is just to exhibit the flexibility of the model).

The primary value of scripting lies in its ability to augment and extend other models to handle special conditions. For example, in compliance testing, it might be necessary to define a business state as being in compliance if either of two condition sets were met. The standard hierarchical model can define compliance as a go/no-go for a total set of resources, but not as an either/or, but it could be extended via script solution model to include this additional test.

Applications of Multiple Solution Models and Multiple Solution Domains

A problem set can be visualized as a single solution domain or as multiple solution domains. Within each solution domain, there may be one, two, or all of the solution models. Where multiple solution models are contained in a single solution domain, the business logic for the domain must provide the mechanism to link the solution models to create a model of the overall solution to the problem the domain is addressing. This is done through internal object linkage. This process may impact the query-building, since each solution model will require its own independent way of parsing its objects into parse paths.

Where a problem is made up of multiple solution domains, the domains are coupled through the mechanism of events. An event is an outside trigger that causes an object query to take place. The standard SOAComply process would treat the operator's command to run a query, or the scheduling of a query at a specified time, as an event.

The process of generating an event is the parsing of a functional object that specifies the event to be generated and identifies the solution domain to which the event is dispatched. That destination domain will have an event handler which will run a specific query for each event type, and that query can then direct the event handling as needed.

Functional Object Overview

An object, in the applicants, or TrueBaseline, model according to the present invention, is a software element that represents a resource, resource commitment, policy, navigating link, or decision element. Objects can be roughly divided into those that are associated with an object agent and can thus be considered linked to an external process, and those that do not and are thus more structural to the model itself.

One class of object agent is the agent that represents a link to resource telemetry. This agent class is employed in SOAComply and is also likely to be used to represent external SOAP2 partners. The other object agent class is the functional agent, and objects with functional agents are referred to as functional objects.

The purpose of a functional object is to create a mechanism whereby a software component can be run at the time an object is processed. This software component would have access to the contents of the query cache at the time of its execution, and it could also exercise the functions that other agents exercise, including populating data variables, spawning “children” or subsidiary object structures, etc.

Preliminary Functional Object Types

The following is a preliminary list of functional objects:
Abort. End processing on the current query and return an error to the query caller.
Activate. Initiate a query with the specified name in the current solution domain.
Alert. Generate an entry in the specified alert queue (and optionally post a result reentry point for when the alert is handled). This is an internal (intra-solution-domain) function; see GenerateEvent for communication between solution domains.
Conditional. Perform an Activate based on a set of tests.
Dip. Perform a database SQL query and post the result in CurrentTable.
Display. Activate a GUI to display a cache, CurrentTable, etc. as a report. Needs to be capable of external linkage to an open source tool.
Discover. Initiate an agent discovery process:
   ScanIPRange for valid addresses
   SpawnObject for each addressed resource.
   Scan4Agent within valid addresses to identify agent type, for each object designated.
GenerateEvent. Signal the specified solution domain with an event of the type specified.
GetEvent. Get an event from the solution domain event queue; used in event handling scripts.
ParseObjectStructure. Parse the object structure identified (by a head or head/tail object) and create a series of route objects representing the parse paths.
ProcessPath. Process the specified route object as a parse path.
ProcessStructure. Process the object structure defined by a ParseObjectStructure.

Additional functional objects are created as needed for a given solution, either by generating custom code or by “wrapping” an external program or module to make it compatible with the Functional Agent interface.

Functional Agents are accessed via an Agent Broker. Each Functional Agent used within a solution domain must be registered with the Agent Broker, and the broker will determine whether the requested Agent is local (and can be called directly) or remote (and must be accessed via a web service). The Agent Broker automatically registers the Functional Agents for GenerateEvent for each solution domain cooperating in a multi-domain application. These domains may be local to each other or remote, and direct posting into the destination Event Queue or web service posting is used as appropriate.

Building Blocks of Building Blocks

Objects are building-blocks in OBJECTive, and solution domains are built from objects. Solution domains can solve any problem, and the general elements of a solution can be pre-packaged for customization. Since a solution domain can actually appear as an object in another solution domain, a packaged solution can be incorporated in many different applications. This approach makes it easier and faster to deploy solutions using the OBJECTive model.

TrueBaseline is developing the following OBJECTive Package Domains for use in its SOAP2 partner program and as elements in current and future TrueBaseline packaged products. Each of these are available as separate solution domains, or as solution models for combining into a single solution domain:
ApplFlowAware, a solution domain that identifies applications, their servers, and the clients that use them. This solution domain can be used to control access to applications, establish requirements for network QoS for specific applications, etc. It is a component of solutions that require monitoring or control of application flows.
ApplElementAware, a solution domain that maintains information on the configuration elements (software components) of applications. This is a component of solutions that require configuration management, and may be used to manage the configuration of a multi-solution-domain installation.
ProtocolProxy, a solution domain that analyzes incoming messages (in the TCP/IP protocol) and processes messages as specified. This is a component of active virtualization and network control applications that are triggered by client/server protocol or directory access mechanisms.
ResourceAware, a solution domain that manages physical resources such as servers and network devices, maintaining their status, configuration, etc. Active control of and changes to systems is also supported. This solution domain is a foundation of most TrueBaseline OBJECTive programs and products.
NetworkAware, a solution domain that models network configurations and provides for network routing and network control. This is a component of solutions that require actual control of network elements.
StorageAware, a solution domain to perform storage virtualization for NAS and SAN storage systems.
PolicyAware, a solution domain that applies policy rules to the handling of events, used as a high-level interface to multi-solution-domain products.
MessageAware, a solution domain that manages messages (email, IM, voice), generating them on demand and converting incoming messages into events for distribution to other solution domains.

The SOAComply product that represents TrueBaseline's first standalone commercial offering is a combination of the ResourceAware, PolicyAware, and ApplElementAware solution models, combined into a single solution domain. Other applications and partnership relationships based on multiple solution domains will be announced in 2006, including ViSPA (Virtual Service Projection Architecture), a complete virtualization solution that binds service oriented architectures and other applications to distributed network resources and optimizes resource utilization while providing full policy management for resource access.

A New Vision of Technology Support for Business

Businesses today confront a growing set of regulatory requirements, the need for “Internet-speed” decisions and interactions with their supply and distribution chain, software complexity, demands for productivity growth, security problems . . . the list seems endless. The problem is that the list of solutions is endless as well, and the problem of managing the solutions has grown to the scale where it's a problem in itself.

TrueBaseline believes that the hierarchical principles of business management, proven through centuries of operations in diverse conditions, must be applied to these new challenges as well, and applied through a set of automated tools that are themselves hierarchical in nature. With OBJECTive, problem/solution definitions at the team or department level are combined and summarized upward. With OBJECTive, every business or technology problem, and every business or technology investment, can be captured in a unified model that exploits the tools available to solve the problems of the present, and of the future.

The OBJECTive framework of objects and solution domains linked into a business-directed structure is the obvious solution to the problems facing businesses today. By making the model able to speak the language

of events, and to link through that language to any business process, OBJECTive is relevant to both today's and tomorrow's business processes. By making it possible to enforce business rules, OBJECTive is a trusted and automated agent of business policy—from work flow to IT security. By wrapping current applications in object form, OBJECTive not only does not displace any solution strategies already in place, it protects and extends current investments.

People will say that business problems are too complex to solve in such a powerful way with a single toolkit, but we say that there is no other way to really solve these problems at all.

Virtualization: Beyond the Ordinary

Today, at this very moment, there are literally millions of technology devices that are supporting a piece of each of our lives. We communicate through technology, we're entertained by it, it keeps us alive and aware, and it even controls a greater and greater piece of our social lives. We'd be lost without technology, and that's a problem in itself, because organizing, managing, and even finding the technology resources we rely on is getting more difficult. In the US alone there are nearly 20 million servers, sixty million disk storage systems, a hundred million network devices, and almost half a billion client devices.

How are millions of technology elements found and harnessed? How can the resources we've come to depend on so much be made available and assured when they are so distributed, so numerous? In particular, how can the technology elements that we need and the networks that deliver their value to us be coordinated? These are questions that have been raised for decades, to be sure, but they are being raised more seriously today, as our dependence on technology increases.

There are answers being proposed. One new software architecture, called service oriented architecture or SOA, promises to create small “atoms” of application features that can be distributed on a network, located through a central directory, and assembled as needed into a whole series of applications. Change one of these application atoms, or “services” as they are called, and the features it provides change uniformly everywhere. It's a powerful concept.

A similar concept in the hardware domain is the concept of virtualization. A user, or an application, interacts not with a real server or disk system but with a “virtual” one, a shadow resource that can be mapped in a moment to a new physical resource to increase capacity, performance, or reliability. Virtualization can also make spare capacity available across the company, the country, or even the world.

Improvements in networking, and in particular the plummeting cost of network capacity, are making these new techniques for managing and applying technology practical as never before. Applications and resources that could have been shared effectively over a single facility via a local network ten years ago can today be spread over a metropolitan area at little more cost. Networks like the Internet make the world a pallet for application components or “services”, and a reservoir of processing power and storage for all to share. If it can be made to work.

There are many proposals on how to make service oriented architectures and virtualization truly effective, but most are incomplete. There is really only one problem, a problem of managing how technology is used. There should therefore be only one solution that covers both SOA and virtualization. Some major industry players, including Cisco, agree with this, but still have not presented a complete solution to the broader, more important problem.

TrueBaseline is happy to be able to propose such a broad solution. We call it the Virtual Service Projection Architecture, or ViSPA. ViSPA is not a single-vendor strategy, but one that envelopes all vendors' equipment. It's not an SOA or virtualization story, but one that includes both . . . and more. ViSPA even embraces the exciting world of open source. It's a completely new way of looking at the problem, a holistic way. We think that's the only approach that will work.

Introducing ViSPA

The Virtual Service Projection Architecture (ViSPA) is a generalized way to virtualize, through the mechanism of network connection, all of the storage, server, and information/application resources used by a business or in the creation of a technology-based service. The goals of ViSPA are:
Work with storage, server, network, and application resources in a common way so that virtualization of resources and service oriented architectures are supported in the same way, with the same tools.
Work with equipment from any vendor, through a simple “wrapper” application that links the equipment to ViSPA's control elements.
Work with any application that uses a standard SOA/web services, Internet, or storage interface.
Incorporate resource security and policy management for all resource types using a common system.
Incorporate distributability and redundancy at any level, automatically, for performance and reliability control and optimization.
Permit extension into new application/user interfaces and resource interface technologies as standards develop.

Creating all of these features in a way that's flexible and extensible demands a new approach to the problem, one based on the most powerful principles available today—the concept of solution domains based on TrueBaseline's OBJECTive Engine, the most powerful and flexible object-based architecture available today.

ViSPA's Structure

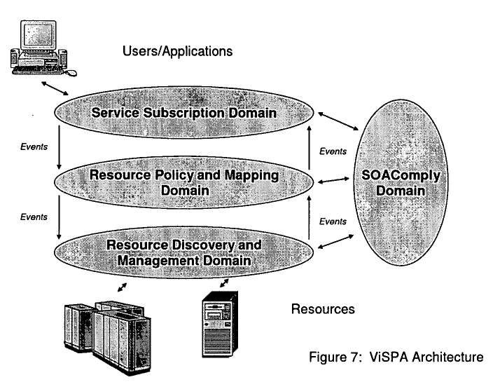

ViSPA takes advantage of the TrueBasline object model capabilities to solve the virtualization problem. In the ViSPA architecture, the basic functions of virtualization are each managed by a separate object model, creating what in TrueBaseline terms is a set of solution domains created from OBJECTive “packaged” solution models, shown in FIG. 7. These domains are coupled to each other through passing events. A fourth solution domain, based on TrueBaseline's SOAComply application, is used to manage the resources on which ViSPA runs and also manage the server resources being virtualized.

Each ViSPA solution domain performs a specific function:
Service Subscription Domain which is a solution domain that manages the interface between the applications and the ViSPA framework. It is this domain that provides the linkage between resource users and ViSPA.
Resource Policy and Mapping Domain which provides the linkage between the subscribing applications and the resources. This is the heart of ViSPA, the main solution domain.
Resource Discovery and Management Domain which identifies resources and maintains their status.

As is always the case with OBJECTive-based solutions, ViSPA solution domains can be divided and distributed to increase performance and reliability as required. The use of “event coupling” of the domains means that each of the above domain functions can be performed optimally by an OBJECTive model and the models can communicate their results to each other to coordinate behavior. This is the same strategy that permits any domain or domains to be “exploded” into multiple models and distributed as needed.

ViSPA Service Subscription Domain

The challenge of resource and application virtualization is best met by recognizing that it is really made up of a number of interdependent problems, each of which must be solved optimally but each of which is also an element in the total ViSPA solution.

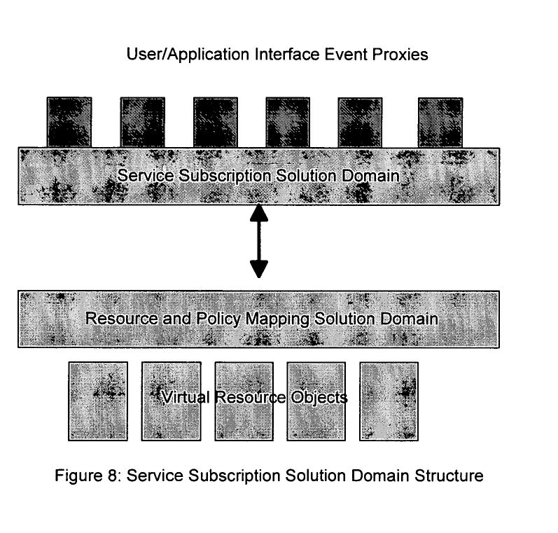

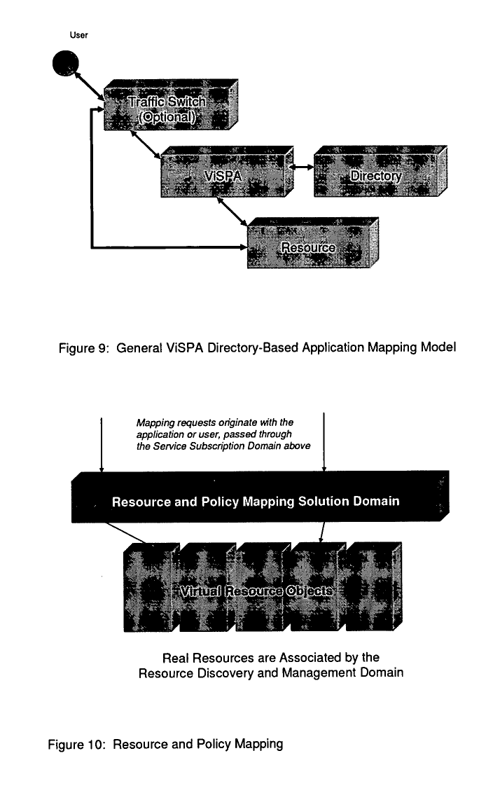

Applications and users must access virtualized resources, and the Service Subscription Domain of ViSPA manages how resources are made visible to and connected with those who use them. FIGS. 8 and 9 show how this domain works.

ViSPA is designed to exploit the fact that in today's network-driven world, there are two distinct steps involved in making use of a resource, whether that resource is a server, a disk, or an application “service”:

1. The resource addressing/locating phase, where the user selects the resource and finds it on the network. This is sometimes called “mapping” or “binding” with the resource.

2. The resource use phase, where information flows between the user and the resource to support the user's needs.

Virtualization, resource policy management, and control of service oriented architectures are all based on the resource addressing phase. This is because processes that control access to resources or map resources to applications are too complex to apply for every record, every message. ViSPA controls the resource addressing phase, and by doing so controls resource policies and directs requests to “shadow” or “virtual” resources to the correct “real” resource.

Where a directory is used (DNS, UDDI), ViSPA becomes the “directory” to the user, and thus receives requests for resource name-to-address resolution. ViSPA provides policy testing and “remapping” of virtual names to IP addresses by changing the virtual name prior to the DNS/UDDI decoding.

When there is no explicit directory, it will be necessary to separate the resource mapping portion of the user-to-resource dialog and redirect that portion to ViSPA in a way that allows the rest of the resource dialog to proceed without interruption. FIG. 9 shows how a “traffic switch” can be used to inspect packets and forward only the mapping dialog to ViSPA while allowing the rest to pass through. This will allow virtualization without an impact on application performance.

Any mapping-spoofing mechanism such as that provided by ViSPA has limitations. To be effective, ViSPA requires that URL/URI decoding not be cached for any lengthy period by the client system if per-access redirection and policy management is to be applied. This requirement is consistent with dynamic agent research work. However, ViSPA can also operate cooperatively with network equipment to exercise greater control over IP address remapping.

ViSPA's Resource and Policy Mapping Domain

The output of the Service Subscription Domain is a set of events that represent isolated user resource requests. These requests have been extracted from the protocol context and formatted for processing by the business rules that establish and manage access rights and work distribution. FIG. 10 shows the structure of the Resource and Policy Mapping Domain.

Each ViSPA resource is represented by a virtual resource object (VRO), which is the view of the resource known to the outside world, meaning to resource users. The basic role of the Resource and Policy Mapping Domain is to link these VROs upward to the user through the Service Subscription Domain. This linkage can reflect policies governing resource use, including:
Access rights, which can be based on user identity, application, time of day, and even the compliance state of each accessing system/client. Access rights management also controls authentication and persistence of authentication, meaning how long it would take for a resource mapping to “expire” and thus require renewal.
Resource status, which includes the load on the resource, time of day, resource compliance with configuration requirements, etc.
Resource scheduling, which includes policies for load balancing, scheduling, etc.
Any other business or technology policies meaningful to the user.

For SOA applications, the Resource and Policy Mapping Domain contains a solution model for SOAP intermediary processing. A SOAP intermediary is a form of SOAP relay or proxy element that handles web services/SOA messages between their origination and their reaching the “ultimate recipient”. Because these intermediaries are elements in the flow of transactions, they represent a way of capturing control of SOAP flows for special processing. However, SOAP intermediaries are in the data path of transactions and thus require performance optimization. ViSPA provides for the optional use of SOAP intermediary processing and allows this processing to be distributed into multiple OBJECTive models for performance reasons and to assure reliability through redundancy.

ViSPA's SOAP processing can also be linked to a SOAP appliance that can analyze SOAP headers and extract requests that require policy or status management, or the application of additional SOAP features such as authentication for identity management. This takes ViSPA's SOAP intermediary processing out of the data path and provides for higher performance and more scalability. When these external appliances are used, the “trigger” conditions for special processing are recognized in the appliance and relayed to an event handler in the Service Subscription Domain.

The SOAP intermediary processing capabilities of ViSPA offer the following capabilities:

1. All SOAP messages (SOA-compliant transaction exchanges) can be routed through a single point that will then distribute the messages as needed according to policy. This is the basis for the other features listed below.

2. Security (both identity management and encryption), message logging and tracing for compliance and auditing, and application load balancing or rerouting.

3. Application awareness, to be applied to controlling network behavior to match application priorities.

Using UDDI mapping and SOAP intermediary processing, ViSPA can provide complete control over web services and SOA applications, including a level of security and reliability that is not available even in the standards. For example, “standard” SOA must expose the directories that link clients to their web services, which means that these are subject to denial of services attacks. With ViSPA, requests for service access can be policy-filtered before they reach the UDDI, eliminating this risk. In addition, identity and security services can be added to any transaction by the intermediary processing, insuring security for all important information flows.

ViSPA Resource Discovery and Management Domain

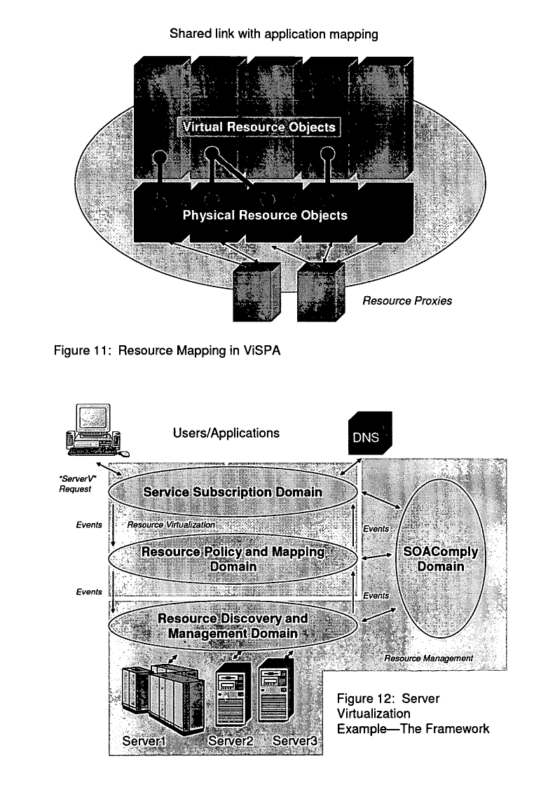

The role of Resource Discovery and Management in ViSPA is to map resources to the Virtual Resource Objects that represent user views of storage, servers, and applications. This is the “bottom-up” mapping function as FIG. 11 shows, a companion function to the “top down” user mapping of the Resource and Policy Mapping Domain.

The creation and maintenance of VROs is managed in this domain. A VRO is created for each appearance of a resource set that ViSPA is to virtualize and manage. This VRO is linked to an external name (A URL or URI, for example) that will allow it to be referenced by the user (through a directory, etc.). The VRO also contains a list of the actual resources that represent this virtual resource—a pool, in effect.

Real resources can be made available to ViSPA either explicitly or through discovery. In both cases, each resource is represented by a Resource Object. Where explicit resource identification is provided, the ROs are created by the ViSPA application itself, based on user input. Where discovery is employed, ViSPA searches one or more ranges of addresses or one or more directories to locate resources, and from this process creates RO. In either case, the RO is explicitly mapped to one or more VROs.

Resource Discovery and Management maintains the link between the VRO and the real resources, but the selection of a real resource based on this “pool” of resources is made by the Resource and Policy Mapping Domain (referred to as the RPMD below). The mapping between “virtual” and “real” resources depends on the specific type of resource and the application. In ViSPA, this is called a virtualization model, and a number of these models are supported:

DNS Redirect Model (server virtualization and load-balancing applications) where the RPMD virtualizes a resource that is located via a URL through DNS lookup. In this model, the virtual resource is represented by a “virtual URL” that is sent to the RPMD, which spoofs the DNS process. The RPMD remaps the DNS request to a “real resource” URL and sends it on to the actual DNS. This model also supports a mode where the virtual URL is the real resource location and the RPMD simply applies policy management to determine if it will forward the DNS request or “eat” it, causing a “not bound” for unauthorized access. Note that in this model, it is important that the client DNS cache time-to-live be set to a short period (60 seconds is the research average) to insure that the client does not “save” an older DNS response and bypass policy and redirection. SOAComply can insure that clients using virtualization are properly configured.

UDDI Redirect Model (SOA/web services applications) where the RPMD virtualizes access to a web service published through a URI in the UDDI. In this model, the “virtual resource” is a virtual URI that is selectively remapped according to policies in the RPMD. This mode is like the DNS Redirect Model in all other respects. This model also requires DNS caching time-to-live be properly set. Note that UDDI redirection takes place before DNS resolution and so either or both can be used in web services virtualization and policy management, depending on the applications.
NAS Model (storage virtualization applications) where the RPMD virtualizes a device or set of devices that represent a NAS (Network Attached Storage) device. The NFS and CIFS models of access are supported on the physical devices. The RPMD impacts only the discovery process here; the actual disk I/O messages are not passed through ViSPA. In NAS applications, ViSPA may or may not be aware of specific files and their privileges/access. ViSPA does not maintain lock state.
SNIA Out-of-Band Model (storage virtualization applications) where the RPMD creates and manages a metadata storage map set that is supplied to the accessing hosts for out-of-band virtualization using the XAM standard. This model will be supported when the XAM standards set is complete (early 2007). ViSPA does not manage volumes, files, locking, etc.; that is done by the disk subsystems.
FTP Proxy Model (storage virtualization applications) where the RPMD remaps a virtual FTP request to a “real” file/resource based on the Virtual Resource Object contents. This model allows a single virtual FTP server to be created from a distributed set of servers.
SOAP Intermediary WS-Addressing/Routing Model where the RPMD maps individual servers who publish web services to a single generic virtual resource that is addressed at the SOAP level and receives the messages designated for any of the real devices. The VRO identifies the server(s) involved in this virtual pool, and the virtualization models represent relationships between the Service Subscription Domain, Resource Policy and Mapping Domain, and Resource Discovery and Management Domain behaviors, and are created using OBJECTive model properties such as Functional Objects. These models can be customized, and new models can be created, using these OBJECTive techniques.
   The SOAComply Domain

One of the resource attributes that can be used to control the virtualization process is the functional and compliance state of the resource. To monitor the state of resources under its control, ViSPA uses the solution models of SOAComply, TrueBaseline's flagship business process compliance management and configuration management product.

FIG. 1 shows how SOAComply works in conjunction with the other VISPA solution domains. The state of all of the resources under ViSPA management, and the state of the resources on which elements of VISPA run are continuously monitored by SOAComply. Whenever a resource that is designated as ViSPA-managed reports a non-compliant condition, SOAComply generates an event to the Resource Discovery and Management Domain, which posts the failure in the RO representing that resource and in each of the VROs to which the RO is linked.

SOAComply will manage the functional state of each resource (its operations status and the basic operating system software configuration) without special application support. To enable monitoring of the server applications needed to support a given application or application set, it is necessary to define the state of the software for these applications to SOAComply in the form of one or more Application Object sets.

Compliance state can be determined in real time or on a periodic basis, and either model is supported by ViSPA. If compliance is “polled” on a periodic basis, the user can set the compliance check interval, and SOAComply will query compliance at that interval and report compliance faults as an event, as described above. If real time compliance checking is enabled, ViSPA will issue an event to SOAComply to activate an ad hoc check for resource status. Since this may require more time, care must be taken to insure that the response time for the real time query does not exceed any application timeout intervals. For most applications, a periodic status check and alert-on-error setting will provide the best performance.

SOAComply also monitors the state of ViSPA itself, meaning the underlying resources on which the application is hosted. This monitoring can be used to create a controlled fail-over of functionality from a primary set of object models to a backup set, for any or all solution domains.

A backup domain set's behavior depends on which ViSPA solution model is being backed up:
Service Subscription Domain backup will substitute the backup SSD for the failed SSD. There is a small chance that a mapping request will be in process at the time of failure, and this would result in a timeout of the protocol used to request the mapping. In nearly all cases, this would be handled at the user level. If backup SSDs are employed, it may be desirable to insure that no changes to the domain object model employ stateful behavior to insure that the switchover does not change functionality.
Resource Policy and Mapping Domain backup will also perform a simple domain substitution, and there is similarly a chance that the mapping of a request that is in process will be lost. The consequences are as above. This domain is the most likely to be customized for special business rules, and so special attention should be paid to preventing stateful behavior in such rules.
Resource Discovery and Management Domain remapping is the most complex because it is possible that the models there are stateful. To support remapping of this domain, ViSPA will exchange RDMD information among all designated RDMD domains and each RDMD domain will exchange a “keep-alive” with the associated RPMD domain(s). If a failure of an RDMD domain is detected, the “new” domain will signal RPMD the resources impacted are “held”, and refresh its resource state information (through the SOAComply domain). When the state information is renewed, the “hold” will be removed. This prevents new mapping to the impacted resources during transition, but existing mapped connections will not be impacted. Individual resource state management policies can be set by the user. Changing the state management policies will change when a given resource is listed as “available”, “impaired”, or “unavailable”, conditions which can be tested in ViSPA for mapping of requests to resources. Thus, users can control resource mapping by status of the resource through changes to these state management rules.

A ViSPA Example

The operation of ViSPA is an interdependent set of behaviors of four or more separate OBJECTive-modeled solution domains. The best way to appreciate its potential is to take a specific example.

FIG. 12 shows a server virtualization application using ViSPA. The four solution domains are illustrated, as are the external resources that are virtualized (the three servers shown) and the directory resources (DNS). As the figure shows, the whole process can be divided into two “behavior sets”, one for resource management and the other for resource virtualization.

The resource management portion of ViSPA (FIG. 13) is required before any virtualization can occur. This management process consists of identifying the resources to be virtualized (the three servers, in this case), assigning these resources a single “virtual name” (ServerV), and insuring that the “real” logical names of the resources (Server1-3) are listed in the DNS. The resources are also identified to SOAComply by creating a resource object for each, and finally the set of applications that are required for proper server operation are identified to SOAComply as an Application Object set.

The second phase of this process is to define all server hardware and application states of each resource that represent “normal” behavior. For example, here we have assumed that there is one state for “normal” processing and one state for “end-of-cycle” processing. Each of these states is represented by an SOAComply query, and that query is associated with an SOAComply event (Events 11 and 12, respectively).

With SOAComply “activated”, it will now test the state of these resources. The tests can be conducted on a periodic basis by SOAComply, or requested with the events shown above. In either case, the result is an event (Event 21 in our example) that informs the Resource Discovery and Management Domain of current compliance state.

In the figure, the virtual resource is identified by a Virtual Resource Object (named “ServerV”) which is associated with three “real” resource objects (Server1-3). The state of these objects is available for query.

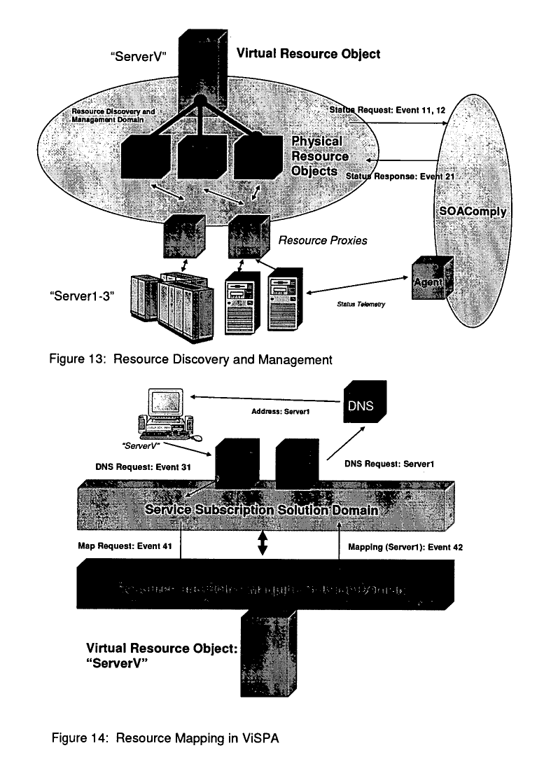

FIG. 14 now shows the virtualization process, which proceeds as follows:

1. A user application wishes to use its server, which it “knows” as “ServerV”, the virtual name.

2. The user application requests a DNS decode of that name, and the request is directed to the user's designated DNS server, which is the event proxy for ViSPA.

3. ViSPA's proxy receives the event (and encodes it as an event 31 in our example) and passes it to the Service Subscription Domain.

4. The Service Subscription Domain validates that this resource (ServerV) is in fact virtualized, and if so creates an Event 41 to the Resource and Policy Mapping Domain. If the resource is not virtualized, the Service Subscription Domain sends the event to the DNS proxy, which simply passes it along to the “real” DNS server.

5. The Resource and Policy Mapping Domain, receiving an Event 41, runs the business rules that define how that event is to be virtualized. These rules do the following:

a. Check to see if the user is entitled to use/see the resource. If “yes”, then proceed, and if “no” return the ServerV request to the real DNS which (since it has no entry for it) will report a DNS error.

b. Run a virtualization rule set that determines, based on a combination of user status, server status, and scheduling rules, which of the three real servers is to be presented on this request.

c. Change the “ServerV” entry to “Server1-3” depending on the result of the step above, and route the event back to the Service Subscription Solution Domain event proxy (Event 32) for delivery to the real DNS.

6. The “real” DNS will now return an actual server IP address for the selected server.

An important point to be made here is that ViSPA may well be the only server virtualization approach that can be made aware of a completely different kind of “virtualization”, the use of a single physical system to support multiple logical systems. Most operating systems today, and an increased number of processor chips, support a form of virtualization where the computer is partitioned to appear as several independent computers, even running different operating systems. Many servers support multiple CPU chips, and some chips support multiple processor cores. The complex relationships between virtual servers and actual resources, if not accounted in resource scheduling, can result in a sub-optimal virtualization decision. SOAComply can determine the real state and status of a virtual server and its resource constraints, and factor this into server load balancing or status-based server assignment.

In this flow, the relationship between the identity of the customer, the status of the server(s), the scheduling algorithm (round-robin, etc.) and even the time of day will have an impact. For example, if the date/time of the request falls into “normal” or “end-of-cycle” periods, SOAComply could post a different resource status for one or more of the resources, resulting in a different selection.

It is also possible that a given user (identified by IP address and/or subnet) might be granted access to a server under conditions others would not. For example, if the CFO wants to run an application that would (for other users) be excluded from Server1 because that server is in end-of-cycle status, the CFO might be given an override and allowed to use that server anyway.

FIG. 15 shows how the ViSPA model can be extended easily to new areas. In the key area of storage virtualization, there are a number of interesting (and competing) approaches currently being proposed by the Storage Networking Industry Association and others. These standards are not yet mature and implementation would be premature at this time. There are similarly interesting open source projects on virtualization of storage, but these projects have not yet advanced to the point where they offer a real framework for business storage management. However, additional objects added to the current domains, or new solution models added to existing domains, or even new solution domains can be easily added to ViSPA. As the figure shows, a new storage system can be created by adding a new Resource Discovery and Management and Resource and Policy Mapping Domain that is dedicated to the storage virtualization process. This would allow the policies for storage management to be separated from those of server virtualization or other ViSPA applications. Despite this separation, the use of events to link domains means that these new capabilities are seamlessly integrated into ViSPA.

SOA, Virtualization, and the Future

There is no question that the concept of virtualization is becoming more and more important to business, more and more promoted by vendors, and more and more confusing. TrueBaseline believes that “virtualization” is simply a means of mapping applications and users to resources in a flexible way, rather than in a restrictive way. As such, it has to be done using an approach that works for all resources and all applications. ViSPA meets those requirements. There are many “in-band” strategies for virtualization of storage and servers. These approaches place hardware switches in the data path between client and resource, with an associated high cost, potential risk to reliability, and almost certain performance impact. While ViSPA can support any hardware virtualization schemes in place or pending, it can also provide virtualization without this introduction of specialized hardware. There are changes to DNS and client address handling behavior needed to optimally introduce ViSPA virtualization, but we contend that these changes benefit the user by reducing costs, increasing their range of equipment choices, and creating a virtualization process that is completely controllable by user policies, something that in-band virtualization cannot be made to be without creating a significant performance bottleneck.

An Object-Based Approach to Complexity Management

Service-Oriented Architecture (SOA) is perhaps the most revolutionary concept in the software industry in a decade or more. SOA divides applications into small components called “services” that can be hosted on a variety of servers, published in a directory, and consumed by users as part of job-specific applications. With SOA, developers create software more flexibly and at lower costs. Users install applications more easily and change them without today's significant software operations burdens. Workers can customize their user interface to exactly match their job requirements. SOA is a tremendous and broad-based win for the software user.

The problem with SOA is that it increases the complexity of software resource management, the difficulty in insuring that servers, clients, and applications are all combining to support essential business goals. SOA does not create all complexity; there are many other factors that are also acting to make the problem of business-to-resource management complicated. A solution to the very specific challenges of SOA, without a solution to all these complicating factors, would simply change the timing or nature of the problem businesses face. The problem is managing complexity, and the way to manage complexity is to automate it.

There are three clear steps in creating an effective, automatic, mechanism for complexity management:

1. You must model the technology resources that are being used to support your business processes.

2. You must model the ways these resources are applied to business problems or to achieve business goals.

3. You must model the business rules that control resource use, that link applications, resources, and business goals together.

When these steps are completed, a computer system can apply business rules directly, and in doing so simplify the way that technology resources are managed. TrueBaseline created such a system with SOAComply, the heart of which is the most flexible and powerful object model in the industry. We are pleased to now offer new applications for that model and to extend our SOAPpartnership program to support those applications.

Object Models as Resource Models: The Lesson of SOAComply

Business technology assets are business resources, and the effective management and use of these resources largely determines how well a business will perform in today's complex marketplace. The problem is that these technology assets are tremendously complex, and making optimum use of them or even understanding how they are being used is often almost impossible.

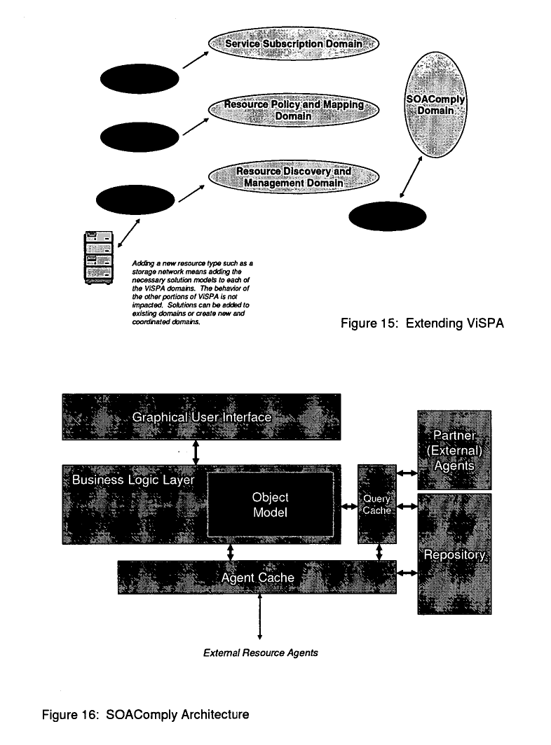

TrueBaseline's solution to the problem of resource usage and management is modeling resources, resource consumption, and business resource policies into a single software/object framework. This framework can then be organized and structured according to business rules. Once that has been done, the object model can then link to the resources themselves and organize and manage them. Manage the objects, and you manage the resources they represent. TrueBaseline does this object management process by creating what is effectively an infinitely flexible and customizable expert system. This expert system absorbs the rules and relationships that govern the application of technology to business processes, either by having the user provide rules or by having a “Wizard” suggest them. The resulting object structure can then analyze resource status and make business judgments on compliance of the resources to stated business goals. FIG. 16 shows this approach.

TrueBaseline's SOAComply product uses this object-based resource management approach to provide the world's only all-dimensional compliance model that monitors system/application resource relationships for all applications, for all compliance standards, for all business goals. Through partnerships in our SOAPprogram of strategic alliances, TrueBaseline can extend SOAComply's resource vision from servers and clients to networks and other business resources. With the extensions to resource monitoring offered by partners, there is no theoretical limit to the types of devices or resources that SOAComply can manage.

This unparalleled flexibility is created by the object model architecture that forms the heart of SOAComply. The notion of “objects” as representative of resources is not new, but TrueBaseline has extended the basic view of objects to include not only physical resources but also applications and other resource consumers, and business processes themselves. This architecture creates all-dimensional compliance modeling through multi-dimensional object structures.

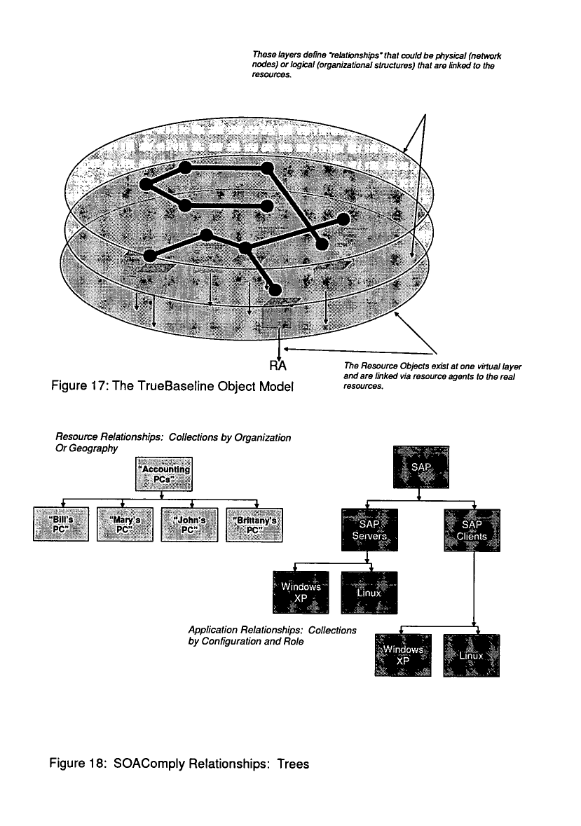

FIG. 17 shows how this works.

Real resources, consisting of computer systems, network devices, or virtually any technology element that can deliver status information using a standard or custom protocol, form the resource layer of the object model. Each of these resources is linked by a resource agent to a corresponding object, which is simply a software “container” that holds information about the resource and its current status. Thus, each resource object in the layer can be queried to find out about the resource it represents. This is very similar to how many network management systems work today, but it's only the beginning of SOAComply's object model capabilities. The real value of the SOAComply model is created by the other layers of this structure. “Above” the resource layer (in a logical or pictorial sense) are a series of relationship layers. Each of these layers defines how the resources below relate to each other. These relationships may be real connections, as would be the case if the resources were interconnected network devices, or administrative groupings like “The Accounting Department PCs”. In SOAComply, relationship layers are used to group resources into logical bundles to help users describe software deployment or divide systems into administrative groups for reporting purposes. Any number of resource layers can be created, meaning that a given set of resources can be “related” in any number of ways-whatever is helpful to the user. Each relationship layer defines a way that a given user or group of users would best visualize the way that applications deploy on systems to support their business processes.

Alongside the set of resources and relationship layers is a second structure, which in SOAComply represents applications. This “vertical” layer structure describes how resources are committed, in this case, how applications are installed on systems to support business processes. Each application has a layer in this new structure, and for each application SOAComply defines a series of operating states that reflect how that application runs under each important, different, business condition. There may be an operating state for “pre-installation”, for “normal processing”, for “business critical processing”, etc. The application object layers are structured as trees, with the top trunk being the application, secondary branches representing client or server missions, and lower-level branches representing system types (Windows, Linux, etc.). These lowest-level branches are linked to the resources they represent in the resource layer of the main structure, as shown in FIG. 18. Resources can be linked directly to applications, or resource relationships (“The Accounting Department PCs”) can be linked to applications to simplify the process.

Resources, resource commitment objects like applications, and business processes can all be assigned an unlimited number of discrete behaviors, called operating states. These operating states can be based on technical differences in how the resources work, on the stage of application installation, on licensing requirements—there is no limit to the way the states can be defined. For each operating state, the object model defines the resource behavior it expects to find.

This combined structure can now be used to check compliance. The user defines a series of business processes, such as “End of Quarter Accounting Runs” or “SOX-Auditable”, as queries, because each of these business processes defines a specific test of resource states based on the total set of object relationships the business process impacts. Each of these processes is linked to one or more applications, and thus to one or more resources.

For each application, the business process definition selects the operating state that application should be in for this particular business process to be considered compliant. When this process is complete, the new query object set reflects the state of resources expected for the specified business process to work. It is on this that SOAComply bases its test for compliance. There can be any number of these queries, each representing a business process goal that could be based on management policy or regulatory requirement. This structure is what provides the flexibility to justify our claim of all-dimensional compliance.

The model of application/resource compliance can include complex business processes with many operating states, as well as many applications and resources. The relationship between all these elements is distilled into a single “go/no-go” compliance test, and users can examine what specific resources were not in their desired state. As useful as this yes/no compliance framework is, it is not the only one that the TrueBaseline object model supports, and compliance queries are not the only application of the model. Four very powerful tools have yet to be introduced. One is the concept of optimum queries, the second distributable modeling, the third the proactive agent, the last the event.

Objects to the Next Level: Optimum Queries

In the TrueBaseline object model, resources, resource commitments, resource relationships, and business processes can all be represented by objects. As FIG. 18 showed, these objects form layers in multiple dimensions. Queries are used to analyze the model representing a business's application of resources to business processes, and these queries return a “comply” or “non-comply” state based on the rules that resources conform to. However, the object model can model any application of resources to business processes and can test rules of any complexity. This permits not only compliance tests but also more complex tests that are more “goal-seeking” than simply go/no-go. “What is the best application” of resources, not simply “Does this application of resources fit business rules”? This is an “optimum query” as compared to a “compliance query”.

Business processes make use of optimum queries in many aspects of their deployment of technology. Network routing, the selection of the best path between two points in a data network, is a good example. Another example is server load balancing. All of these examples have one thing in common; there are multiple ways of accomplishing the same thing, each having costs and benefits. The trick is to select the one that is “best” according to business rules. TrueBaseline's object model uses a special model we call a dynamic business resource mesh to define any business process that has multiple possible approaches to the same goal and one best one must be selected.

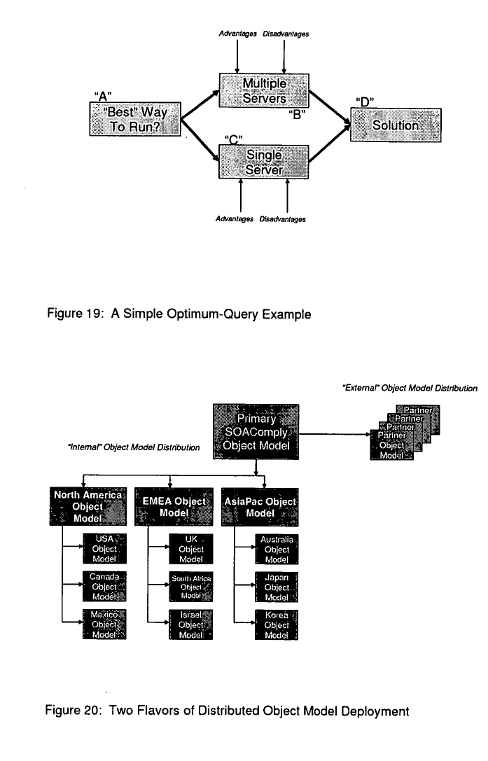

FIG. 19 shows a simple example of a dynamic business resource mesh. Here multiple “approaches” to the goal at the right consume different resources and impact different resource relationships that the business has established. For example, a task could be performed by dividing it into multiple pieces and assigning each piece to a different server. However, this division and parallel assignment loads all the servers down for the period of the task, and so might interfere with other tasks. How much benefit can be obtained by selecting that path over the one where only one server is used? The answer depends on how important the task being assigned happens to be, relative to other tasks that might be interfered with. There are plusses and minuses to each approach.

The problem could have even more dimensions. For example, it is also possible that one or more of the servers is owned by a hosting company and must be paid for if used. That creates another sort of cost that must be managed according to business rules. Finally, there may be a benefit to completing the task early, in the form of faster time to market, the ability to take a discount on an invoice, etc. The more factors (both advantages and disadvantages) there are to consider and the more separate decisions there are to be made on each path (there is only one on each path of the example), the harder it would be to assess them manually and make the correct decision.

The TrueBaseline object model models the tasks, resources, and rules (including both rules relating to cost and those relating to benefit). When this modeling is complete, the model can then find the optimum solution to any problem of resource allocation the model covers, over a wide range of parameters about the task. Feed the model an optimum query with a specific set of assumptions and it will provide the business-optimized result, considering as many factors as needed.

This architecture defines a tremendously flexible and scalable form of expert system, an artificial intelligence tool that allows a computer system to enforce a model of rules that an “expert” has previously defined and validated. TrueBaseline makes every business an expert, gives every business a way of expressing the rules for application of technology to business processes. These rules are then applied by software, and the results of the application are communicated to the user. The results will match the rules, every time, without the need for manual analysis. No matter how complex the environment, the rule-based processes of our object model reduce them to either a simple yes/no compliance summary, or an optimum business choice.

In the FIG. 19, the path A-B-D has been selected by the model on the basis of an optimality score that combines all its advantages and disadvantages according to business policies previously defined. Since the advantages and disadvantages are established (directly or though a wizard) by the user, the decision is the one the user would have made by following normal policies and practices. This result can be used by management to implement the decision the model points to, or it can illustrate another strength of the object model, the proactive agent capability described later in this application, to directly control technology elements and implement all of or part of the decision without manual intervention.

Objects to the Next Level: The Distributable Object Model

The most convenient way to visualize the TrueBaseline object model is as a single collection of objects representing, resources, resource consumers, and business processes, all linked with business rules built around operating states. However, the object model and the business logic were designed to be distributable, meaning that the object model can be divided and hosted in multiple locations.

FIG. 20 shows an example of how a distributed object model can be used in SOAComply or any application built on the TrueBaseline object model engine. In the figure, the SOAComply user has a business that is large, widely distributed geographically, and is involved in many supply- and distribution-chain partnerships. To deal with this complex business, the buyer has employed object model distribution at two levels.

The first level of distribution is intra-company, to allow the company's worldwide business to be separated by region and even country. Each region/country runs its own local object model, collecting compliance information according to local rules. This allows regional and national management to control their own practices, subject to corporate review of their rules (easily accomplished through SOAComply). The key compliance indicators for each country are collected into the appropriate region and then upward into the headquarters system. This concentration/summarization process means that enormous numbers of resources and rules can be accommodated without performance limitations. The object model still allows each higher level to drill down to the detailed information if a problem is uncovered.

The second level of distribution is inter-company, to allow the SOAComply buyer to extend application compliance monitoring to partners who might otherwise create voids in compliance monitoring. When the company decides to extend one or more applications for partner access, the partner may not want to expose all the resource and application data from their own environment, and so the object model acts as a filter, limiting the visibility of private data while still insuring that the information needed to determine compliance is available for rule-based processing. Because the rules run on the partner system's object model the partner can control the level of detail access; if needed to the point where only the go/no-go compliance decision is communicated.

The secondary object models shown in the figure can be either complete installations of SOAComply or simply a “slave” object model operating through the user and reporting interfaces of the main installation. In the former case, the secondary sites will have full access to SOAComply features; in the latter case only the primary site will have the GUI and reporting capabilities. Where multiple full SOAComply installations exist in partnership, each installation can have a secondary object relationship with the other, so a single SOAComply implementation can be both “master” and “slave” to other implementations, without restriction.

This same model of distribution works with any application built on the TrueBaseline object model, a feature that will be described further in the sections below.

Objects to the Next Level: the Proactive Agent

As we explained earlier, each resource object has an object agent that provides telemetry on the object status, thus generating the parameters on resource behavior that are tested by the business rules in queries. These agents gather intelligence on which business decisions are made, but they can also provide a mechanism for control in a proactive sense; the object model can control the resource and not just interrogate it for status. Control capability must be explicitly set at three levels in TrueBaseline's model for security purposes:

1. The object model must be defined as running in proactive mode. This definition is set on a per user basis when the user signs on to the TrueBaseline application. Thus, no user without the correct privileges can control a resource.

2. The software agent in the resource object must permit control to be exercised. Proactive-capable agents must be explicitly linked to a resource object or no control is possible.

3. The resource itself must have an internal or installed agent that is capable of exercising control. For example, many management agents will read system values but cannot set them. Unless a proactive-capable agent is running in the resource, no control is possible.

4. The query must call for control steps to be taken. Even if a query is running in proactive mode, it does not automatically exercise direct resource control.

If all these requirements are met, a query of any type can generate a control command to a resource. This command can, depending on the nature of the agent elements and the query itself, perform tasks like setting system parameters, issuing local device commands, or running processes/programs. Commands issued by queries are always journaled to the repository for audit purposes, and this function cannot be disabled.

Commands can be used to bypass manual implementation of certain functions. For example, a command can send an email to a designated list of recipients with a specified subject and body. It could also cause an application to run, allocate more resources to a network connection, run a script to quarantine a specified computer, open or close ports in a firewall, run a backup or restore, etc.

Often object-based rules that can actually change resource or application behavior are subject to special security or have special performance constraints. Where this is the case, these rules can be separated from the primary object model into a subsidiary model like ones shown in FIG. 20 and run independently. Because commands can be issued in response to query conditions, they can automate the response to non-complying conditions, which may be critical in creating an auditable compliance response to many business problems or circumstances, but the capability is particularly powerful when used with the last expanded feature of the object model, the event.

Objects to the Next Level: the Event

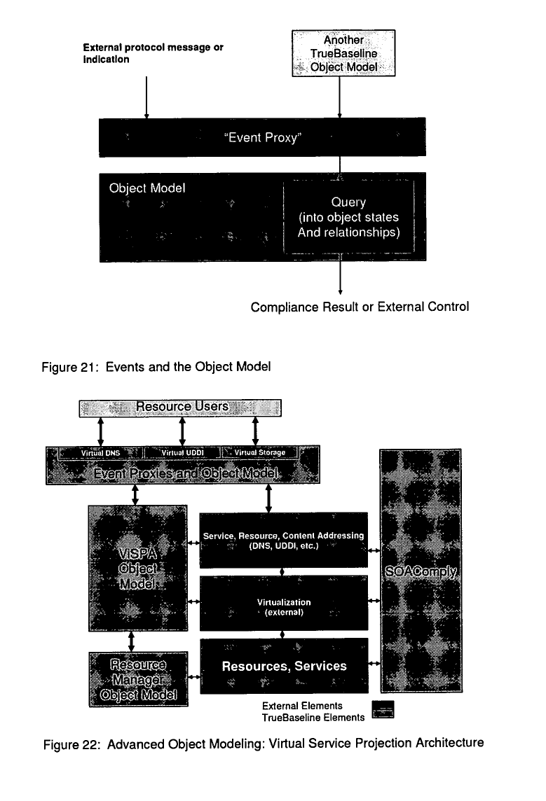

The queries we have described so far are ones that are initiated by a user of the TrueBaseline object model, such as a signed-on user to SOAComply. However, queries can also be automatically initiated by the reception of an event, which is an outside condition recognized by the TrueBaseline object model. FIG. 21 shows how events work.

All events are recognized through one or more proxies, which are software elements that monitor a source of real-time data (such as a particular communications connection) and analyze the data for specified conditions. These software elements “speak the language” in which the event is communicated. In theory, anything that can be made visible to a software process can be an event source. This includes not only things like a special protocol message on a communications line, but also a temperature warning in a computer room, the scanning of a specified RFID tag, or even the go/no-go decision of another query. In fact, an event can be generated by a secondary object model, thus providing a means for linking multiple object models into a coordinated system.

As the figure shows, a proxy is actually a query of an event-managing rule structure. This structure can be used to generate a go/no-go decision or an optimize decision, it can use pure telemetry or exercise active control. An event-driven structure such as this can be used to answer the question “What should I do if the computer room temperature rises too high?” or “What happens if the main server is down when it's time to do quarterly processing” by making the “question” something that comes from an external event. In the first case, that event might be an environmental sensor, and in the second it might be the result of a compliance query that finds a server offline.

The use of the TrueBaseline object model to manage event handling is a very critical step in the automation of business processes. Because the object model incorporates multiple dimensions of compliance with rules, because business rules can be linked to resources, applications, or business practices, and because the model recognizes the large number of business operating states, it is an ideal framework for applying decisions automatically.

Since an “event” is any external condition that can be communicated to software, the model can actually drive business decisions. The combination of event-based queries and proactive control means that the object model can actually appear as a processing element, a server or node. For example, the object model could be used to create a system that decodes logical system names found in HTML URLs or XML URIs (universal resource locators/indicators, respectively) into IP addresses, a function normally supported by a Domain Name Server (DNS). This might be done because the user wanted to apply security to URL decoding (only specified systems can access this resource, and thus only they can obtain the address), for load balancing or work distribution in a computer grid (the object model returns the IP address of the next active server when asked to decode a server logical name) etc. It is this capability that makes the object model a suitable framework for service/resource virtualization.

Resource virtualization is the process of separating the logical concept of a resource, the concept that the resource consumer “sees”, from the physical location and identity of the resource. This separation allows a collection of resources to be substituted for the logical resource, and the mapping between these pieces can be controlled by the virtualization process to offer fail-over, load balancing, etc. The key to virtualization is a set of rules that describe how resources are mapped to users, and the TrueBaseline object model is the most flexible model of business, resource, and access rules available.

To make resource virtualization efficient, it is critical that the virtualization process not interfere with the actual use of the resource, only aid in locating it. Most resource access technologies have two distinct phases of operation, a “mapping” phase and an “access” phase. The DNS example above shows that website access naturally divides this way, and SOA relies on a central directory of services (usually called the UDDI for Universal Description, Discovery, and Integration). This directory links the servers on which the actual software resides and the applications that use it. Most storage protocols similarly have a “mapping” phase of resource location, and any resource access protocol with a mapping phase can be virtualized using the TrueBaseline object model.

Resources are normally located by a form of directory, usually seen as a database, but it can also be a TrueBaseline object structure. If this is done, then the object model can apply security, load-balancing, access logging, and other features to the SOA software being run, greatly enhancing the SOA process. Better yet, by integrating SOA UDDI management, DNS management, and network monitoring and control into the object model, the network and application behavior of SOA an be integrated and controlled in a way that others are only dreaming of. We call this the Virtual Service Projection Architecture. ViSPA is a reference implementation of all of the features of the object model, incorporating an open source framework to deliver a complete virtualization architecture for resources and services.

Virtual Service Projection Architecture (ViSPA)

At the network level, SOA's impact is less clear and its benefits may be overshadowed by its risks. SOA creates what is essentially a new network layer on top of IP, a layer with its own virtual devices, addressing and routing, language and protocols, etc. For several years, startup vendors have been promoting equipment for this new network, and recently application/system vendors like IBM and network vendors like Cisco have entered the fray, acquiring or announcing products that will manage the networking of SOA.

The problem is that unlike IP networking, SOA networking has no clear rules, no “best practices”. We know the logical elements of SOA networks, things with arcane names like “originator”, “ultimate recipient”, and “SOAP intermediary”. We know that SOAP networking is likely related to the concept of virtualization of resources, grid computing, or storage networks, in some way. But few can draw an SOA network diagram or name providers for the pieces. Even recent SOA networking announcements like Cisco's Service-Oriented Network Architecture (SONA) are strong on goals and light on details.

TrueBaseline is a software development company who developed a resource/operations object model to facilitate the “operationalization” of complex software systems as they responded to increased demands for compliance to business practice and regulatory policy goals. This object model is state of the art, linked with Artificial Intelligence concepts, and capable of modeling any complex relationship between resources, resource consumers, and business practices. SOA networking is such a relationship, and TrueBaseline is now announcing an SOA networking application of its model, called the Virtual Service Projection Architecture or ViSPA.

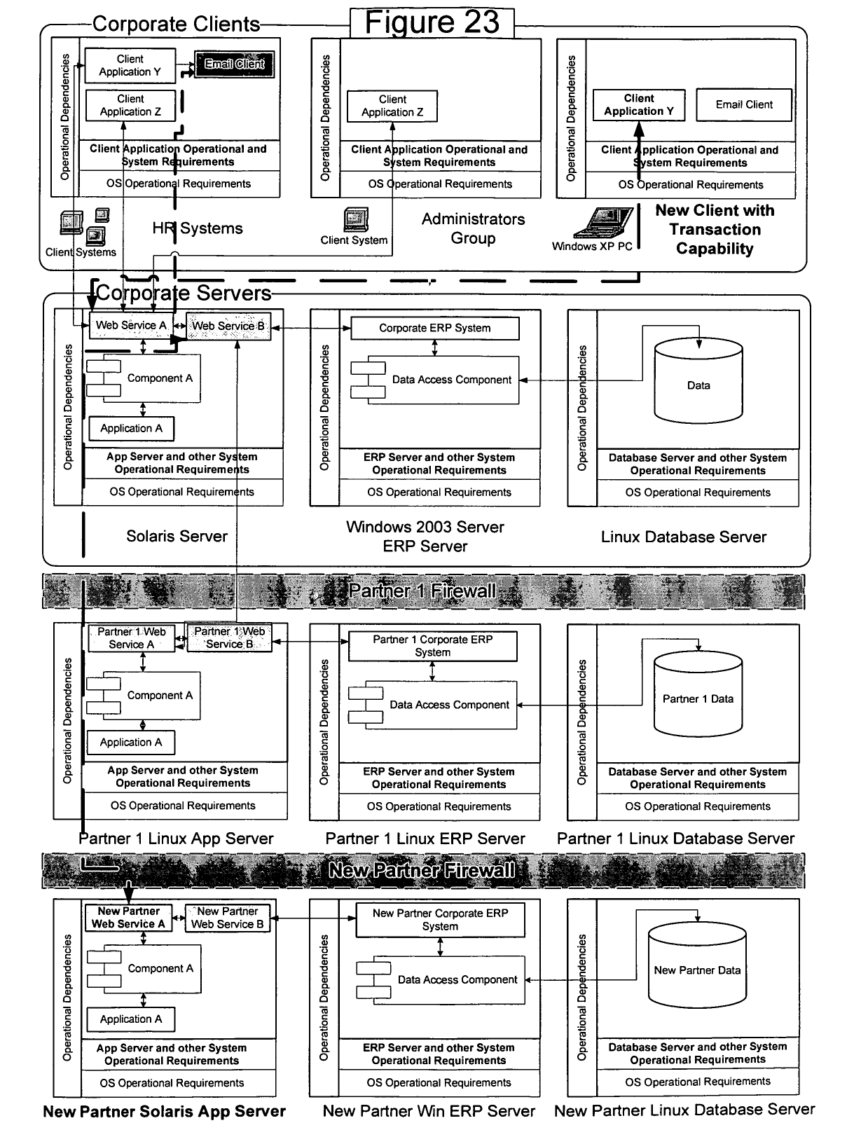

FIG. 22 shows the ViSPA architecture, a reference architecture for all of the advanced features of the object model described above. The resource users at the top of the figure interact with the resource mapping function using a series of well-defined standard protocols such as those established for DNS or UDDI access. However, these functions are directed instead at an event proxy function at the top layer of ViSPA. There, the object model decomposes the request using predefined rules, to establish if this particular resource has been virtualized. If the answer is that it has not, the request is simply passed through to the real directory. If the answer is “Yes”, then the object model applies the sum of the security, balancing, fail-over, and other virtualization rules and returns a resource location to the requestor based on these rules. There is no limit to the level of complexity of the rules to be applied, and the rules can be based on user identity, server identity, the nature of the request, the loading of or status of various servers or other resources, etc.

To insure that ViSPA performance levels are high, the process of resource monitoring is handled independent of ViSPA by TrueBaseline's SOAComply product. In addition, both the ViSPA object model and SOAComply can be partitioned into multiple object models as described above for performance and availability management. ViSPA object models can be created using SOAComply object authoring tools and wizards, but can also be directly created by a SOAPpartner using tools provided for that purpose. The object model is compatible with operation on high-performance servers and custom appliances, and this combines with the distributability to insure that ViSPA can sustain very high performance levels.

All virtualized resources are monitored continuously by SOAComply, which means that resource monitoring includes not only the load status of the resource, but also the software and other business rule compliance of the resource. This provides a level of flexibility and control that is not available in most resource virtualization techniques, which deal only with the load and operating status of resources. With the support of partners in TrueBaseline's SOAPprogram, the network connection between resources and resource users can also be monitored and, in some cases, controlled. The sum of the status of the resources/network are communicated to ViSPA which then uses them to apply business- and resource-specific rules for access and balancing of requests.

The figure illustrates the proactive control capabilities of the object model. Virtualization rules ultimately will yield either the location of the resource to be mapped, or an indication that no resource is available. This state is returned to the requestor through the operation of the proactive agent, which communicates with the appropriate proxy to send the correct message. The figure also shows a proactive “Resource Manager” that receives information from both the ViSPA virtualization object model and the SOAComply object model and can be used to change resource state, to command network configuration changes, or even to support automated problem notification and escalation procedures.

SOA Operationalization: Facilitating a Software and Application Revolution

There's a new software game in town, something called “service-oriented architecture” or SOA. The good news is that it's going to change the way software is built and used . . . and as you've probably guessed, that's the bad news too.

Business Week called web services and SOA the “most important—and hotly contested—trend to hit software in a decade”. It's certainly a trend that has captured the support of the key vendors. Microsoft, IBM, SAP, BEA, Sun, HP . . . all of these companies have major web services SOA strategies. In fact, every single major software or system platform vendor has one, and is advancing that strategy at full speed. Major enterprise software buyers are probably involved in several projects with these vendors, and all of them will bring a degree of SOA or web service dependence to their operation. The Yankee Group's latest SOA survey, released Aug. 23, 2005, predicts that in twelve months, we can expect SOA adoption rates exceeding 90% in retail and finance, and better than 75% in manufacturing and government.

Why then is it also true that surveys have shown that less than a third of these same enterprises say they have SOA plans? Why are less than half the software and IT planners even literate on the basic concepts of SOA? How will the low state of buyer awareness collide with the fast pace of seller commitment? Revolutions change everything, and if SOA is indeed a revolution then a low state of buyer literacy means a high state of buyer risk arising out of the changes. In fact, SOA is colliding with a second major IT trend—the trend of compliance in its broadest sense—and this collision will create a very substantial risk to SOA adoption, and to those who adopt it. It's a risk that must be, and can be, controlled, because companies can't be asked to choose between failure to comply with statutory, certification, and license requirements on one side and modern and flexible software technology on the other. We believe that the SOA revolution demands a counter-revolution, a revolution in how applications are operationalized, how they are integrated with hardware to become available, functional, compliant business tools. In fact, without some operationalization revolution, we believe SOA adoption will be seriously delayed, even compromised.

What is SOA and Why Do I Care?

As we've already noted, SOA stands for “Service Oriented Architecture”. It's a new way of doing software design and development, a strategy to bring the open, easy, client-server architecture of the Worldwide Web to application software. With SOA, an application is divided into small components called “services”, and these services are then published in a directory just as web pages are published in the Internet. Clients access this directory to assemble these services into applications.

Web services is a set of standards published to create an SOA using tools based on the web. Despite the name, web services isn't necessarily associated with the Internet in any way. Companies can (and normally do) deploy applications based on the web services standards for their own workers' use, but may also extend some of these applications to partners in the supply side or distribution side of their business. SOA and web services create a flexible, distributable, application framework but they don't demand users change their current access practices. Still, it is fair to say that one of the primary drivers of SOA and web services is the desire to interate business practices, by integrating applications, along the partnership chain from the earliest raw-materials suppliers to the final link . . . the customer.

The reason why SOA and web services is revolutionary is first that it breaks the old model of distributed computing, a model where application clients and servers were tightly linked to each other. This tight linkage made it difficult to deploy applications to new users, whether inside or outside the company. The second revolution is in the ability to essentially “author” applications by assembling services, a feature that the Business Week article highlighted. This lets applications be tailored to the needs of each of the application's users without creating a whole series of specialized clients or application versions. Building an application with web services is in theory as simple and flexible as building a web page.

The benefits of web services in particular, and of the higher-level concept of SOA, are many, but the main reason users should care about these ideas today is that they're the basis for the evolution of the whole of the software industry into a new form. Users, confronted by the PC and LANs in the 1980s, might have wanted to stay with central mainframes and dumb terminals, but like it or not ended up in the PC and distributed computing age. Users today can decide to embrace SOA, but they are almost certain to end up embracing it even if they don't decide to do so, because it's the direction all their software and systems vendors are moving. Current applications are being translated to SOA form, and future applications will be targeted for SOA. If the best business software creates the best business practices, then SOA is in everyone's future, even down to small to mid-sized businesses.

One thing that the “supplier push” motivation for SOA adoption creates is a management risk. With buyer literacy on SOA concepts low and with every SOA software and platform vendor pushing their own approaches, users run the risk of creating an application framework for their business that they cannot control. Many of the companies who eventually embraced distributed computing had significant problems managing their new distributed applications. In fact, many of those problems are still being sorted out today as companies try to manage software versions, license terms, and patches/fixes in a maze of different desktop and laptop computers, departmental and centralized servers. How will SOA, which loosens the links between application pieces, impact this kind of problem? How might it also impact some of the complex business regulations companies are now facing, such as Sarbanes-Oxley?

The “Compliance Dimension”

The term “compliance” has come to mean the conformance of business practices to federal and state laws that arose largely out of the “bubble period” that ended in 2001. The Sarbanes-Oxley Act, which spells out disclosure and governance practices for businesses, is the linchpin of the current compliance furor, but compliance has a much broader meaning, and also some very specific software implications.

We believe that “compliance” is really a multifaceted issue. There are actually four primary sources of “compliance requirements”, all of which impact software deployment and operation in some direct or indirect way. They are:
Information security, privacy, and disclosure laws. These establish controls and safeguards for consumer data, and thus impose specific requirements on software tools that use or manage this data. HIPAA (Health Insurance Portability and Accountability Act) is such a law. Failure to comply with these laws can result in fines, civil suits, or both.
Business practices regulations. These establish rules of business behavior that may apply to the company's marketing and sales, production, operations, and investor management processes. Examples include SEC regulations, Sarbanes-Oxley, etc. Failure to comply with these laws can also generate fines and civil suits.
License agreements. Software licenses often stipulate the number of copies of a program that can be legally run. Companies who fail to enforce these rules are subject to fines and civil suits.
Certification programs. The ISO 9000 program and other manufacturing and operations certification programs all require specific programs for managing defects, correcting problems, auditing operations, etc. Failure to enforce these programs can result in loss of certification, and thus to loss of credibility. Note that state and local requirements may also apply, and that there are special compliance requirements associated with multi-national operation.

All of these “compliance” sources have generated headaches for IT professionals who provide the software tools that either manage business operations or specifically support compliance goals. The concepts and goals of “compliance” at the business level have been translated to what is often called “IT governance” in the software world. IT governance has to be derived from all four compliance sources, and that task can be very significant. The IT Governance Institute issued a six-volume description of IT governance practices, called the Control Objectives for Information and Related Technologies (COBIT). The goal of these IT governance programs is achieving what we'll call All-Dimensional Compliance, the IT support of the totality of business and information standards, regulations, and practices that involve systems and applications. Given the lack of specific IT requirements in most of the compliance sources, that can be a murky goal. Enforcing IT governance can be even more murky. A governance plan has to be translated into a measurable set of software objectives, and these software objectives must then be monitored to insure that they are being met. For most organizations, this means insuring that a specific set of software tools is being run, that specific software parameters are selected to control application behavior, etc. The task isn't made simpler by the fact that vendors have approached the compliance and IT governance issue in pieces rather than as a whole, so there are “security compliance” and “license compliance” solutions.

Some users, and vendors, have endorsed general concepts of system management to solve the problem of IT governance, often by applying those concepts to limited areas like version management, license management, or security. This approach translates to simply checking to see if there is an executable file (in Windows terms, a Dynamic Link Library or DLL) present on specific computers. The problems with this approach are obvious. There is no support for auditing systems to insure that the program installed there will run correctly or on the parameters used to run it. In a world where “thin client” and “browser-based” applications are becoming more common, there may be no DLL to check at all, and SOA-based applications are more likely to be “thin” than today's distributed applications. But the biggest loophole in the system-management-IT-governance link is the fact that there is no assurance that the configuration check process will ever be up-to-date with the applications and versions being run. The approach demands that “maps” be created for various systems to reflect what should be running there, and if these maps become outdated then the whole governance process is discredited. SOA applications, with their native ability to be extended outside the company to suppliers and distribution partners or even customers, magnify this problem tremendously. Is a company who extends its applications to a partner immune from compliance requirements because of that decision? Hardly, and yet how would a company insure its IT governance practices were enforced outside its own systems? Would partners grant visibility into their IT infrastructure to permit systems reviews? Most companies know they'd never offer their own partners such visibility today, but how can IT governance work in the age of SOA without that ability?

FIG. 23 illustrates the magnitude of this problem by illustrating the dynamic and distributed nature of SOA business process. The solid blue line is an example of a sample SOA business process transaction that involves participation of several ingredients (systems, databases, applications, components, web services, partners etc). The blue dotted line illustrates the fact that SOA enables agile businesses to meet on-demand business requirements by being able to improve partner, client and service participation etc to create additional revenue. If the business considers this application to be the successful cooperation of all of these ingredients, then how can the user be sure the elements that are involved are actually equipped to participate as they should? For each system resource, there is a collection of software and hardware elements needed to support the application, and lack of even one such element anywhere in the chain can break it, and the application, and the business processes it supports.

It is very clear from the above diagram that a multi-tier SOA business process spans across several applications, several Operating Systems, several Server and Client Systems, several corporate firewalls, and several networks. In between the two application end points there are several moving points and in some cases depending on the business needs the end points of the process are also moving points which make SOA a very dynamic environment to manage. To make things worse each point in turn depends and relies on several ingredients at that point, or some other point, for it to be operational. An example would be a web service running on a Linux server requiring a certain version of the OS and Application Server middleware tools. If the service is accessing data from an ERP system it requires the Inventory Web Service of the ERP system to be operational, which in-turn requires the ERP system to be constantly running on another system resource, which in-turn relies on the data accessing components being available on that other system . . . the chain of events required for successful operation is almost impossible to describe and even harder to enforce, and this chain of requirements could exist for dozens or more applications, and these applications could be changing requirements regularly.

The more agile the businesses are, the more agile their business processes are. The more agile the business processes are, the more dynamic their supporting SOA IT processes must be. More dynamic SOA processes means more “floating” connecting points, more loose associations between clients and servers, services and resources. Each of these loose associations is a single point of failure that might cause the entire process to collapse, resulting in a loss of revenue, partner frustration and resistance towards SOA acceptance.

Operationalization, Compliance, and SOAComply Technology

The multiple sources of compliance requirements, the multiple paths to solution that vendors seem to be taking, and the potential explosion in the number of clients and software elements that SOA adoption will bring seem destined to create a kind of perfect storm of problems for the enterprise, and even mid-sized businesses. What is needed is an orderly approach to the problem. Service providers call the process of optimizing the management and support of technology a process of “operationalization”, and we think the term is a good one for the software, SOA, and compliance space as well. We also think that SOA/compliance operationalization has to start with a vision of an application. There are three primary requirements in operationalizing an SOA application:
Establish the integrity of SOA application elements and their communications during the application installation process
Manage dynamic elements in SOA business processes and facilitate their operations during application use.
Verify the removal of application elements when an application is decommissioned or when a system is withdrawn from the pool of resources that can host or access the application.

While these broad goals are probably widely acknowledged, they are not systematically supported. Each piece of the SOA puzzle is handled and managed separately. Web services management systems ensure that the web services are running properly, database management systems ensure that the databases are running properly, system management ensures that the client and server systems are running properly, application management assures the application . . . there is an overabundance of solutions.

Sadly, there is no one integrated approach to managing the entire SOA application business process from end to end because there is no management system available that has total application awareness. For example, web services management system can tell a user that a web service is not responding but cannot provide the intelligence to the user as to what are the business processes that are affected as a result of this failure. The broader the use of SOA in an enterprise, the greater the nightmares to the very IT managers and CIOs who are the SOA visionaries behind the decision making process.

Imagine deploying a complex SOA process that spans across several points. Each point requires a completely different set of pre-requisites for a successful deployment and a successful utilization of all features of an SOA process. An example could be a Windows financial application client that consumes the corporate financial data from a web service. Imagine rolling out this client to all the systems in the finance departments, not knowing that only 80% of them have the necessary Windows Service pack level, only 90% have the necessary disk space, and only 70% have the necessary pre-requisite application Adobe Acrobat 7.0 running. Depending on how these limitations were distributed, it could well be that less than half the target users will actually be able to run the application.

Even when the applications are running, there is no assurance that they will continue to run correctly. Other applications could interfere, critical components could become out of date or be removed, and resources could be consumed. If SOA applications are not exercised regularly, these failures might not be detected for days, weeks, or even months, and yet any loss of participation in an SOA application for any reason would compromise the business activities built on that application.

The need to satisfy All-Dimensional Compliance requirements add a new dimension of risk to SOA that an SOA Operationalization solution must address for good installation, operation, and control practices that are not technical but business/regulatory. For example, a company's IT governance practices could mandate use of certain applications for data backup, but there is normally no way of knowing whether these are installed or used. The same policy might forbid use of certain software elements such as peer-to-peer networking, or mandate certain security tools. In neither case is there a reliable strategy to enforce these requirements, or even to understand where among all the clients and servers in an enterprise a given set should be enforced.

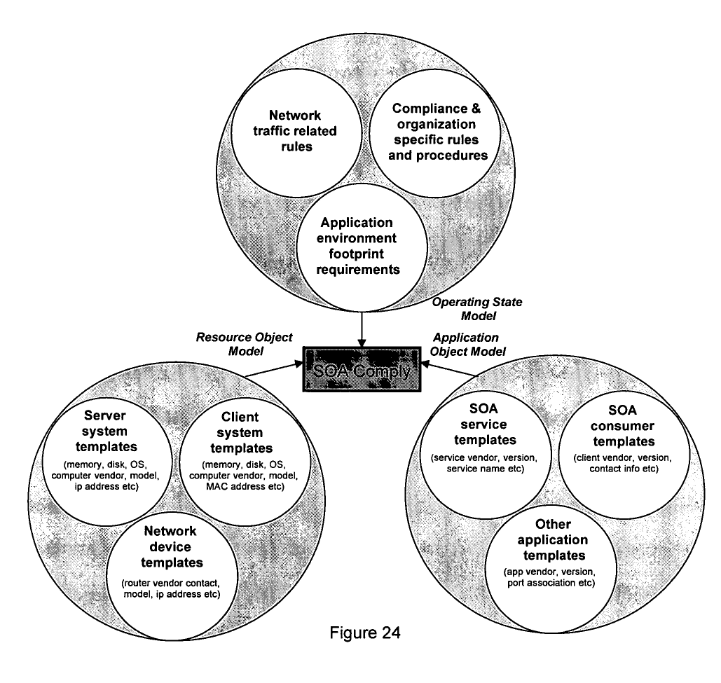

Businesses deploy applications to support their mission, and those applications are both sources of compliance support (Sarbanes-Oxley tools) and sources of compliance issues (software license and security management). We believe that operationalizing an SOA evolution has to be based on what that revolution is deploying—applications. Our application-based All-Dimensional Compliance solution for the SOA-empowered (or empowering) enterprise is SOAComply. This revolutionary SOA Operationalization tool is based on a combination of application object modeling, system object modeling, operationalization rules, and application footprints. FIG. 24 shows the relationship between these four key areas.

The key to any effective operational control over any technical process is getting it organized. As the figure shows, SOAComply begins with an object modeling process that defines the two key elements in an SOA deployment, the applications and the system resources they use. The object models are defined in XML using a TrueBaseline “template”, and can be generated in a variety of ways:
The user can develop template for an application or system resource, either using authoring tools and guidelines provided by TrueBaseline or by modifying various sample templates we provide with OAComply.
The user can obtain a template from an application vendor or system vendor who subscribes to TrueBaseline's SOA Application/System Registry Program.
The user can download a template from our library of contributed and certified templates. Object templates in SOAComply have a common structure. Each contains a group of elements that identifies the object, its source, etc. For example, an application object might be called “SAP CRM”, with a specified version number, a software vendor contact, and internal IT support contact, an application contract administrator contact, etc. A system resource object might be called “Bill's Desktop”, and identify the computer vendor, model, system attributes, operating system, etc.

Both application and system resource objects are associated with operating states, the key central element to the SOAComply structure. Application deployment can be divided into a series of states or phases, each having its own requirements. TrueBaseline has defined four states of application behavior:

1. Pre-Install. This state defines system requirements which must be met before an application is installed.

2. Install. This state defines the system requirements which must be met to certify that application installation has been performed correctly.

3. Operation. This state defines the system requirements which must be met while the application is running in a manner consistent with all-dimension compliance requirements.

4. Decommission. This state defines the system requirements which must be met to certify that an application has been successfully uninstalled.

The operating state information provides rules SOAComply software will enforce to validate the status of any application on any system it might run on. These operating states are expressed in the form of operationalization rules and “application footprints” which are a set of conditions that should be looked for on a resource. Every application will have a footprint associated with each of its operating states, and for any given system (client or server) there will be a composite footprint that will represent the sum of the application needs of that system at any point in time, based on the combination of the applications the system is expected to support and the state of each.

To monitor for All-Dimensional Compliance, SOAComply instructs a software agent running in each system resource to check the composite footprint of that system against the current operating conditions and to report the status of each system, file, registry, or environment variable that any application expects. This data is then correlated with the object model data and any discrepancies noted. For each noted out-of-compliance condition, SOAComply identifies all the applications impacted by that condition and performs a notification/remedial action based on the operationalization rules.

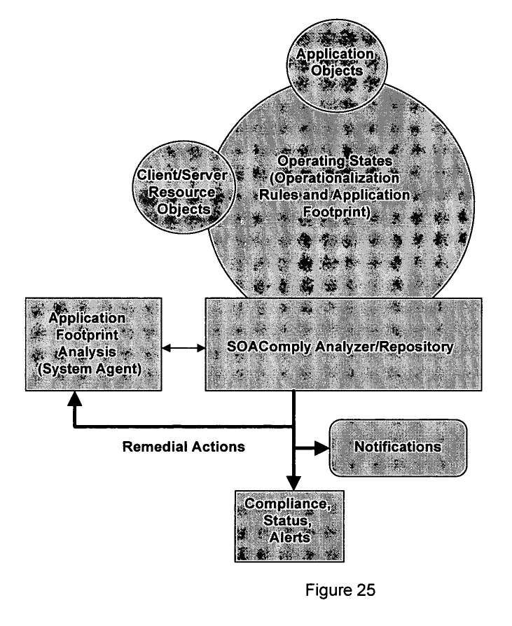

FIG. 25 shows graphically how all these elements combine to create All-Dimensional Compliance:
Application vendors or other sources provide application templates that represent the footprint requirements for each application in each of the operating states.
System vendors or other sources provide system resource templates that represent each client and server system.
The customer signals SOAComply that an application is to be deployed by associating system resources to the application's template. This process adds the application's operating state information to SOAComply's agent monitoring process.
As applications and resources are added or changed, SOAComply's analytical software examines the combination of applications and resources and calculates a compliance footprint for each system resource. This footprint is used to interrogate system resources to establish the state of their critical variables, and whether that state matches the requirements for the sum of applications the system is committed to supporting.
The SOAComply agent, at a predetermined interval, obtains information from each system and reports it back to a central analysis and repository. There, SOAComply checks it against the composite application footprint. If there are discrepancies, the analyzer scans the applications certified for the system and identifies each one whose current operational state is impacted by the discrepancy. For each impacted application, the remedial steps defined in the application/system rules is taken. The SOAComply solution is the only strategy available to organize, systematize, operationalize, and sustain an SOA deployment. It brings a new level of order to the SOA process, order needed to preserve business control of applications deployed with as flexible a tool as SOA. With SOAComply, businesses can capture the benefits of SOA and avoid the risks.

Organizing SOA: Collections of Resources and Applications

The processes defined in the previous section provide the framework for analyzing and interpreting application states in client and server systems. Even at this level, SOAComply is a giant step forward in SOA Operationalization, but other tools and facilities of SOAComply make it even more valuable.

Client and server systems are not just randomly placed pieces of technology, they are a part of organizations and work processes, along with those who own, use, and support them. SOAComply provides a valuable modeling capability that reflects the organization of systems as well as their technology. It's called the resource collection. A resource collection is a group of resources combined as members of a user-defined higher-level resource. For example, accounting applications are most likely to be deployed to the Accounting Department. With SOAComply, users can create a resource collection called “AccountingDepartment”, and list as members all of the servers and client systems owned by workers in that department.

Now, when deploying applications, the user can simply indicate that the application is to be deployed to the “AccountingDepartment” and all of the systems listed there will be incorporated in the application's rules. The association between resources and resource collections is dynamic, which means that when a new system is added to the AccountingDepartment, for example, it is added to the application systems list for all of the applications that reference that AccountingDepartment resource collection.

Membership in a collection is not exclusive, so a system can be a member of many resource collections, and these collections need not be based on organizational assignment alone. For example, a resource collection of “WindowsXPSystems” and “LinuxSystems” could be defined based on the operating system of the computer involved. That would permit the user to identify all of system resource of a given technical type.

The resource collection is valuable not only for its ability to streamline the definition of what systems get a particular application, but also for defining compliance rules. A user can identify special compliance rules for any resource collection, and these rules will be applied by SOAComply just as application rules are applied. That means that it is possible to establish special configuration and application requirements for AccountingDepartment or LinuxSystems.

Applications can be “collected” as well as resources. An application collection is a group of application rules that should be considered as a whole in managing compliance but must be broken down to create a proper operationalization framework, perhaps because the application must be installed on multiple software/hardware platforms with different configuration rules. An application collection called “CustomerManagementSystem” might consist of two collections, one called “CMSLinux” and the other called “CMSWindows”, and each of these might then include other system resources or yet more collections. Collections provide a unique and valuable way of organizing rules for IT governance that reflect the relevant technical and business divisions that control how governance works.

When a collection is built, the properties of the high-level collection are obviously based on the properties of the things being collected. The AccountingDepartment collection has members (presumably the clients and servers in the accounting department) and in most cases references to the collection is intended to be a simple shorthand way of referencing all of its members. However, it is also possible with SOAComply to apply a concept of selective inheritance. For example, one property of a system is its operating system (Linux, Windows, etc.) A resource collection called “WindowsSystems” could be created by a user and populated manually with those systems running Windows OS. However, the user might also simply maintain one or more master lists of resources, perhaps a list called MyServers and MyClients, and identify the operating system of each. Now, a collection of WindowsSystems could be defined in SOAComply as containing those MyServer and MyClient systems with the property of OperatingSystem=Windows Server 2003 and Windows XP respectively. In other words, a collection can “collect” only those members who match specific requirements.

Selective inheritance can also be used in conjunction with the software features of SOAComply to limit resource visibility, for situations where companies cooperate in application use because they are part of each other's supply or distribution chain. A user might define a collection “PartnerInventoryClients” to represent the user's suppliers in a just-in-time manufacturing inventory system. Each supplier might create a collection “MyUsersOfXYZCorpInventory”. In this collection, the suppliers would use selective inheritance to specify just what system parameters or application rules could be visible to the partner, thus creating a controllable and secure compliance audit process that crosses company boundaries.

All of this is accomplished by allowing each resource or application (individual or collection) to specify just which of its rules/properties will be visible to collecting elements created above it—what it will allow collections to inherit. Similarly, each collection can specify what individual rules/properties of the members it wishes to inherit. Either can be made conditional; a member of a collection must meet a condition test (the system is running Windows XP, for example) or a collecting object must meet a certain test (be owned by my own company, for example) for this property to be visible to it. When SOAComply collects information on the operating state of resources, it applies these filters to limit how much information about a given resource will be presented for view. Information privacy, a compliance requirement itself, is a natural feature of the SOAComply model.

Collections and selective inheritance make SOAComply the most powerful tool in organizing applications and application components for distributed use that has ever been developed. It's useful even in legacy distributed applications; it's critical in SOA.

Extending SOAComply

The resources and application templates that make up SOAComply are based on XML and are extensible and flexible. In fact, SOAComply has been designed to be extended in many different ways, and TrueBaseline is in discussion with various partner organizations to develop programs that offer these extensions.

One basic extension to SOAComply is to define additional operating states. As we indicated in a prior section, we provide four basic operating states in SOAComply, representing the four phases of application deployment, use, and decommissioning. However, users or application vendors can define additional states to reflect special needs, such as a multi-stage installation process where one set of tools must be installed and verified before another is installed, or to reflect the need of certain systems to obtain a security audit before being admitted to an application.

A second extension to SOAComply is to define additional application rule types. Application rules, as we have noted, are normally definitions of the operational requirements of an application and reflect the application's use of resources and need for certain environmental conditions. These rules are applied to system resources, but additional application rules could be defined to link network behavior, for example, to operating states. TrueBaseline will provide, under specific agreement with partners, a specification for the development of an Application Rule Element that would provide a link between an operating state and a set of system, network, or other application requirements beyond the normal environmental requirements SOAComply would test and monitor.

These capabilities can be used in synchrony to create a series of application operating states that reflect not only the status of an application in terms of its ability to run correctly on the target systems, but also its network status, and the health of the total business ecosystem of which the application is a part. As FIG. 25 shows, SOAComply can be the central linking point in any network, service, system, or operations monitoring and management process whose goal is to support and control application behavior. It is the only system on the market that can operationalize not only SOA and applications, but an entire business.

The Business, the Goal, the Conclusion

The software revolution that Business Week talks about is real, but it's only a shadow of the real revolution, which is the business process changes that are both drivers of and being driven by SOA. Technology can revolutionize business, but the only important technologies in the business space are the ones that actually succeed.

SOA is the most significant software concept of the decade because it is the most interdependent with the business process. That interdependency creates an enormous opportunity to rethink business practices in terms of how technology can enable them, not simply apply technology to pre-tech practices and hope for the best. The IT industry as a whole has been groping for something like this since the early days of computing.

If SOA is more than technology, then SOA Operationalization is more than technical system analysis. If the application and the business process are to intertwine, then the operationalization of both must take place in one package, with one method, with one control point. We believe that the SOAComply model provides that, and in fact is the only solution on the market that can even approach it.

Revolutions aren't always won. The Business Week assertion that the SOA revolution was “hotly contested” shows there is a real debate raging on SOA, its benefits, and its impacts. We believe that this debate is created in large part by the fact that there is no operational model for an SOA framework, no way to insure it meets either technical or business goals.

APPENDIX A is a paper discussing the object architecture relationships in the SOA Comply aspect of the invention.

APPENDIX B is a paper discussing the application of the present invention in service management solutions.

APPENDIX C is a paper discussing the resource plane of the TrueSMS product implementing part of the present invention.

APPENDIX D is a paper discussing element and service schema.

APPENDIX E is a paper discussing event driven architecture in connection with embodiments of the present invention.

APPENDIX F is a paper discussing TrueSMS process flows.

Although the present invention has been described with particularity herein, the scope of the present invention is not limited to the specific embodiment disclosed. It will be apparent to those of ordinary skill in the art that various modifications may be made to the present invention without departing from the spirit and scope thereof. The scope of the present invention is defined in the appended claims and equivalents thereto.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. An object-based modeling system comprising:
at least one model object representing a resource and an agent link associated with said model object, said agent link determining the status of the resource and exercising control over the resource;
a solution domain defined and stored on a computer medium in which said model object is stored; and
a set of at least one rule associated with said model object for application to said model object.

2. A method for modeling a process comprising the steps of:
creating at least one model object representing a resource and an agent link associated with said model object, said agent link determining the status of the resource and exercising control over the resource;
creating a solution domain defined and stored on a computer medium in which said model object is stored; and
creating a set of at least one rule associated with said model object for application to said model object.

3. Computer apparatus for modeling a process comprising:
at least one model object representing a resource and an agent link associated with said model object, said agent link determining the status of the resource and exercising control over the resource;
a solution domain defined and stored on said computer apparatus in which said model object is stored; and
a set of at least one rule associated with said model object for application to said model object.
